(19) United States
(12) Patent Application Publication
(10) Pub. No.: US 2025/0023254 A1
(43) Pub. Date: Jan. 16, 2025

(54) PASSIVE REFLECTARRAY PANEL FOR ENHANCED WIRELESS COMMUNICATION IN NEAR FIELD COVERAGE AREA AND METHODS OF DESIGNING THE SAME

(71) Applicant: METAWAVE CORPORATION, Carlsbad, CA (US)

(72) Inventors: Alvaro FERNANDEZ VAQUERO, Gijón (ES); Manuel ARREBOLA BAENA, Gijón (ES); Eduardo Maria MARTINEZ-DE-RIOJA DEL NIDO, Madrid (ES); Jose Antonio ENCINAR GARCINUÑO, Madrid (ES); Taha SHAHVIRDI DIZAJ YEKAN, Carlsbad, CA (US); Maha ACHOUR, Carlsbad, CA (US)

(21) Appl. No.: 18/711,356

(22) PCT Filed: Nov. 24, 2022
(86) PCT No.: PCT/EP2022/083150

§ 371 Date: May 17, 2024

(30) Foreign Application Priority Data
Nov. 24, 2021 (EP) 21383064.9

(51) Int. Cl. H01Q 19/10; H01Q 3/46; H01Q 15/00

(52) U.S. Cl. CPC H01Q 19/10; H01Q 3/46; H01Q 15/0046

(57) ABSTRACT

Examples disclosed herein relate to a reflectarray panel for near-field wireless communication coverage area and designing the reflectarray panel. The method includes one or more following steps, including, determining a near field coverage area of the reflectarray panel, calculating a tangential reflected field on a reflectarray surface of the reflectarray panel based at least on a feed location and initial geometric parameters of the reflectarray surface, determining radiation pattern specifications with an incident beam pointed toward a center of the near field coverage area, performing a near-field pattern synthesis algorithm on an initial phase distribution of the reflectarray panel, determining a synthesized phase distribution on the reflectarray surface from a result of performing the near-field pattern synthesis algorithm, adjusting one or more geometric parameters of each reflectarray cell of the reflectarray panel to produce the synthesized phase distribution, and/or determining dimensions of the reflectarray panel for manufacturing.

### TECHNICAL FIELD

The present disclosure relates to wireless communication systems, and in particular, relates to reflective phased array antennas for enhanced wireless communication coverage area, including for near field applications.

### BACKGROUND

New generation wireless networks are increasingly becoming a necessity to accommodate user demands. Mobile data traffic continues to grow every year, challenging the wireless networks to provide greater speed, connect more devices, have lower latency, and transmit more and more data at once. Users now expect instant wireless connectivity regardless of the environment and circumstances, whether it is in an office building, a public space, an open preserve, or a vehicle. In response to these demands, new wireless standards have been designed for deployment in the near future. A large development in wireless technology is the Fifth Generation of cellular communications (“5G”), which encompasses more than the current Long-Term Evolution (“LTE”) capabilities of the Fourth Generation (“4G”) and promises to deliver high-speed Internet via mobile, fixed wireless and so forth. The 5G standards extend operations to millimeter wave bands, which cover frequencies beyond 6 GHz, and to planned 24 GHz, 26 GHz, 28 GHz, and 39 GHz up to 300 GHz, all over the world, and enable the wide bandwidths needed for high speed data communications.

The millimeter wave (“mm-wave”) spectrum provides narrow wavelengths in the range of ˜1 to 10 millimeters that are susceptible to high atmospheric attenuation and have to operate at short ranges (just over a kilometer). In dense-scattering areas with street canyons and in shopping malls for example, blind spots may exist due to multipath, shadowing and geographical obstructions. In remote areas where the ranges are larger and sometimes extreme climatic conditions with heavy precipitation occur, environmental conditions may prevent operators from using large array antennas due to strong winds and storms.

In particular, future developments and integration of 5G technologies for user wireless communications represent a great challenge. Specifically, base stations for 5G wireless communications need to provide constant power over a certain angular range. In this respect, the antenna is an important subsystem for wireless communications, since it is the device that converts the guided waves into propagating waves in free space and vice versa. Different parameters of the antenna may be optimized depending on the application, such as size, radiation pattern, matching, etc. In many cases, a shaped-beam pattern is necessary to adequately redirect power to the desired area. These and other challenges in providing millimeter wave wireless communications for 5G networks impose ambitious goals on system design, including the ability to generate desired beam shapes at controlled directions while avoiding interference among the many signals and structures of the surrounding environment.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates an environment in which a reflectarray antenna is deployed to enhance wireless communications in accordance with various implementations of the subject technology;

FIG. 2A illustrates a schematic diagram of a reflectarray antenna with various cell configurations in accordance to various implementations of the subject technology;

FIG. 2B illustrates a schematic diagram of a field distribution as a function of distance for a reflectarray antenna for enhanced wireless communication coverage area, in accordance with various implementations of the subject technology;

FIG. 3 illustrates a flowchart of an example process for designing a reflectarray antenna for enhanced wireless communication coverage area in accordance with various implementations of the subject technology;

FIG. 4 illustrates a schematic diagram of an example of a planar reflectarray antenna and a considered unit cell in accordance with various implementations of the subject technology;

FIGS. 5A and 5B illustrate schematic diagrams with cross-sectional views of reflectarray antenna stack-up configurations in accordance with various implementations of the subject technology;

FIGS. 6A and 6B illustrate plot diagrams of phase and amplitude curves as a function of the dipole length for the X-polarization in accordance with various implementations of the subject technology;

FIG. 7 illustrates a flowchart of an example process for performing the near field pattern synthesis of FIG. 3 to optimize a reflectarray antenna design, in accordance with various implementations of the subject technology;

FIG. 8 illustrates a schematic diagram of a geometry setup of a base station relative to a reflectarray antenna, in accordance with various implementations of the subject technology;

FIGS. 9A-9E illustrate plot diagrams of phase and amplitude curves as a function of the dipole length for the X- and Y-polarizations for a given reflectarray cell in accordance with various implementations of the subject technology;

FIGS. 10A-10C illustrate phase distribution and far field radiation patterns of a defocused beam of a reflectarray in accordance with various implementations of the subject technology;

FIGS. 11A-11D illustrate plot diagrams of main cuts in azimuth and elevation of far-field radiation patterns and near-field radiated power density of a defocused beam of a reflectarray in accordance with various implementations of the subject technology;

FIGS. 12A-12B illustrate the phase diagrams of phase distribution on a reflectarray panel using a far field synthesis (12A) and the phase difference with respect to the phase distribution obtained by the defocused beam technique in accordance with various implementations of the subject technology;

FIGS. 12C-D illustrate the far field radiation patterns in horizontal (H) and vertical (V) polarizations, produced by the far field synthesis for a given reflectarray panel in accordance with various implementations of the subject technology;

FIGS. 13A-13D illustrate plot diagrams of main cuts in azimuth and elevation of far-field radiation patterns and near-field radiated power density based on far field synthesis of a reflectarray in accordance with various implementations of the subject technology;

FIGS. 14A-14C illustrate phase distribution using a near field synthesis and the phase differences with respect to the phase distributions obtained by defocused beam (14B) and far field (14C) synthesis approaches in accordance with various implementations of the subject technology;

FIGS. 15A and 15B illustrate plot diagrams of main cuts in azimuth and elevation of near-field radiated power density based on near field pattern synthesis of a reflectarray in accordance with various implementations of the subject technology;

FIGS. 16A and 16B illustrate plot diagrams of far field radiation patterns based on near field synthesis for a reflectarray cell in accordance with various implementations of the subject technology;

FIGS. 17A and 17B illustrate plot diagrams of main cuts in azimuth and elevation of far field radiation patterns based on near field pattern synthesis of a reflectarray in accordance with various implementations of the subject technology;

FIGS. 18A and 18B illustrate 3D plot diagrams of field radiated at different distances for a reflectarray cell using near field (A) and far field (B) approaches in accordance with various implementations of the subject technology;

FIGS. 19A-19E illustrate comparison diagrams (ripple in the coverage, power density in the coverage and radiation intensity) calculated at different distances for a reflectarray cell in accordance with various implementations of the subject technology;

FIG. 20 conceptually illustrates an example of reflectarray antennas in an outdoor environment in accordance with various implementations of the subject technology;

FIG. 21 illustrates an environment in which a reflectarray antenna can be deployed to significantly improve 5G wireless coverage and performance in accordance with various implementations of the subject technology;

FIG. 22 illustrates placement of reflectarrays in an indoor environment in accordance with various implementations of the subject technology;

FIG. 23 conceptually illustrates an example of a reflectarray antenna in an indoor environment in accordance with various implementations of the subject technology;

FIG. 24 conceptually illustrates an electronic system with which one or more implementations of the subject technology may be implemented;

FIG. 25 illustrates a flowchart for a method of performing pattern synthesis of a reflectarray antenna for near-field wireless communication, in accordance with various implementations of the subject technology; and

FIG. 26 illustrates a flowchart for another method to calculate the pattern produced by a reflectarray antenna for near-field wireless communication, in accordance with various implementations of the subject technology.

### DETAILED DESCRIPTION

Reflectarray antennas are suitable for many different 5G and other wireless applications and can be deployed in a variety of environments and configurations. In various examples, the reflectarray antennas are arrays of cells having conductive printed elements that reflect incident radio frequency (“RF”) signals from a feed into a focused, directional beam in a single direction. The reflectarray antennas are able to operate at higher frequencies for 5G wireless networks and at relatively short distances. The reflectarray cells, which, as generally defined herein, may be engineered, non- or semi-periodic structures that are spatially distributed to introduce a specific frequency-dependent phase distribution. Their design and configuration are driven by geometrical and coverage area considerations for a given application or deployment, whether indoors or outdoors.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

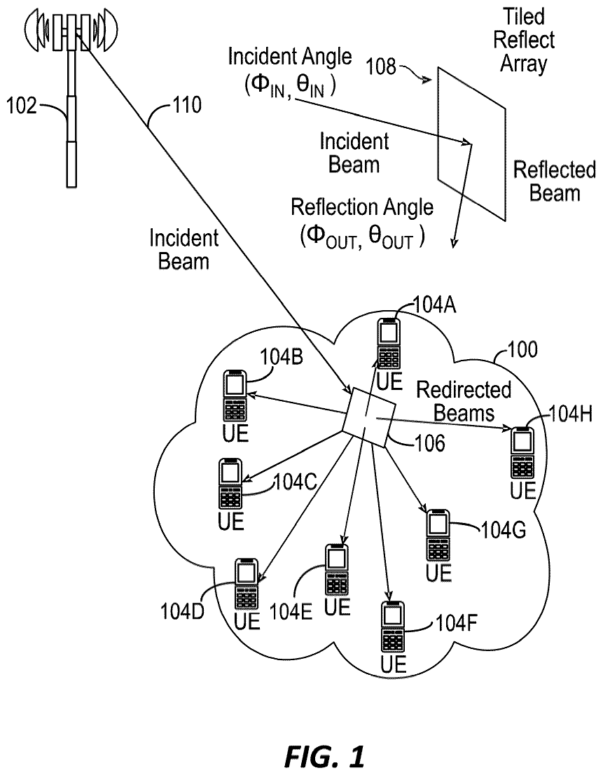

FIG. 1 illustrates an environment in which a reflectarray panel (also referred to herein as “reflectarray”) is deployed to enhance wireless communications in accordance with various implementations of the subject technology. A wireless network 100 serves user equipment (“UE”) within transmission and reception range of at least one wireless base station (“BS”), such as BS 102. BS 102 transmits and receives wireless signals from UE within its coverage area, such as UE 104A-H. The coverage area may be disrupted by buildings or other structures in the environment, which may affect the quality of the wireless signals. As described in more detail below, wireless coverage for UE 104A-H can be significantly improved by the installation of a reflectarray panel 106 within their vicinity. Although a single reflectarray panel 106 is shown for illustration purposes, multiple such reflectarray panels (or antennas) may be placed in wireless network 100 as desired. In accordance with various embodiments, a reflectarray antenna includes a reflectarray panel and a feed, where a BS acts as a feed to the reflectarray panel.

In various examples, the reflectarray panel 106 can serve as a passive relay or active relay between BS 102 and UE 104A-H. The reflectarray panel 106 receives a signal from the BS 102 at an incident angle (or direction) and reflects the signal into one or more directional beams aimed for the UE 104A-H. Cutout 108 depicts the incident beam coming from an incident angle with elevation angle θ_{IN} and azimuth angle φ_{IN}, and depicts the reflected beam radiating at a reflected angle with elevation angle θ_{OUT} and azimuth angle φ_{OUT}. The directivity of the reflectarray panel 106 is achieved by considering the geometrical configurations of the wireless network 100 (e.g., placement of BS 102, distance relative to the reflectarray panel 106, etc.) as well as antenna specifications for the reflectarray panel 106 in network 100, as described in more detail below. Various configurations, shapes, and dimensions may be used to implement specific designs and meet specific coverage area constraints. The reflectarray panel 106 can be placed in any wireless network environment, be it in a suburban quiet area or a high traffic area, such as a high-density city block. Use of a reflectarray such as the reflectarray panel 106 and designed as disclosed herein can result in a significant performance improvement of even 10 times current 5G data rates. The reflectarray panel 106 is a low cost, easy to manufacture and set up reflectarray, and may be self-calibrated without requiring manual adjustment to its operation.

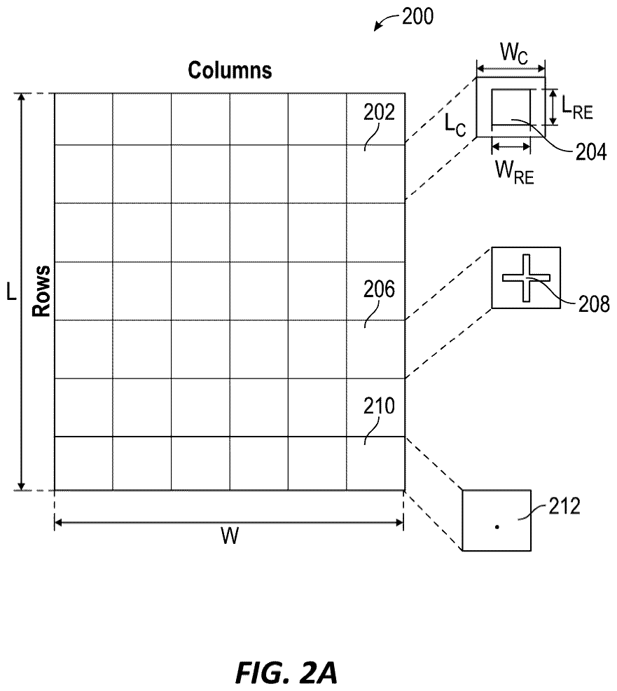

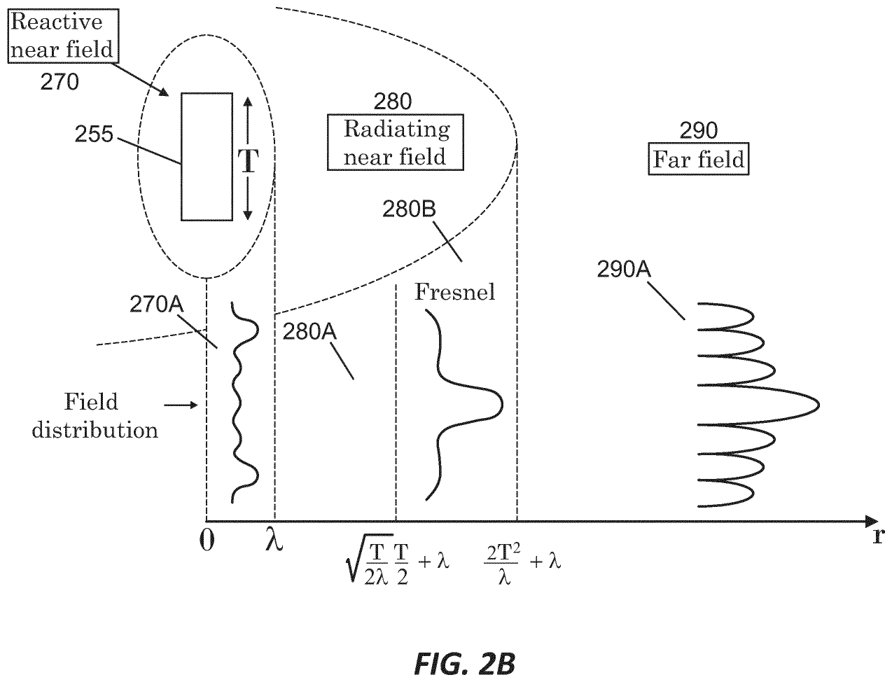

Attention is now directed to FIG. 2A, which illustrates a schematic diagram of a reflectarray panel 200 with various cell configurations in accordance to various implementations of the subject technology. The reflectarray panel 200 includes an array of cells organized in rows and columns. The reflectarray panel 200 may be passive or active. A passive reflectarray may not include any active circuitry or other controls, as once in position it passively redirects incident beams into a specific focused direction. The reflectarray panel 200 provides directivity and high bandwidth and gain due to the size and configuration of its individual cells and the individual conductive printed elements within those cells.

In various examples, the cells in the reflectarray panel 200 include conductive printed patches of different shapes. In other examples, the reflectarray cells may be composed of microstrips, gaps, patches, dipoles, and so forth. Various configurations, shapes, and dimensions may be used to implement specific designs and meet specific constraints. As illustrated, reflectarray panel 200 is a rectangular reflectarray with a length l and a width w. In other examples, the reflectarray panel 200 may be circular with a radius r. Each cell in the reflectarray panel 200 has a conductive printed element. The conductive printed elements may also have different configurations, such as a square patch, a rectangular patch, a dipole, multiple dipoles, and so on. Other shapes (e.g., trapezoid, hexagon, etc.) may also be designed to satisfy design criteria for a given 5G or other wireless application, such as the location of the reflectarray panel 200 relative to a BS, the desired gain and directivity performance, and so on.

For example, the reflectarray panel 200 includes a cell 202 that is a rectangular cell with dimensions w_{c} and l_{c} for its width and length, respectively. The cell 202 includes a conductive printed element 204 with dimensions wᵣₑ and lᵣₑ. The dimensions of the conductive printed element are in the sub-wavelength range

$$( \sim \frac{λ}{3} ) ,$$

with λ indicating the wavelength of its incident or reflected RF signals. In other examples, the reflectarray panel 200 includes a cell 206 that has a cross-dipole element 208. As described in more detail below, the design of the reflectarray panel 200 is driven by geometrical considerations for a given application or deployment, whether indoors or outdoors. The dimensions, shape and cell configuration of the reflectarray panel 200 will therefore depend on the particular application.

Attention is now directed to FIG. 2B, which illustrates a schematic diagram 250 of a field distribution as a function of distance for a reflectarray panel 255 for enhanced wireless communication coverage area, in accordance with various implementations of the subject technology. As illustrated in FIG. 2B, the diagram 250 shows a field distribution 260 as a function of distance r from the reflectarray panel 255. The field distribution 260 closest to the reflect array panel 255, for example, within a distance λ from the reflectarray panel 255 is a radiative zone referred to as reactive near field 270. The field distribution in the reactive near field 270 is illustrated to show a field distribution 270A. For example, for a reflectarray panel 255 with a side length of about 0.4 meter, the λ is determined to be 0.0107 meter based on the

$$relationship = \frac{{c}_{0}}{f} ,$$

where c₀ is light velocity in vacuum and f is frequency of the electromagnetic radiation, for example at 28 GHz.

As illustrated in FIG. 2B, the next nearest field after the reactive near field 270 is referred to as radiating near field 280. The radiating near field 280 is divided into two regions 280A and 280B. In accordance with various embodiments, the region 280A of the radiating near field 280 is defined as between λ and

$$\sqrt{\frac{T}{2 λ}} \frac{T}{2} + λ ,$$

where T is a largest dimension of a panel, such as the reflectarray panel 255 shown in FIG. 2B. \sqrt{2}·side length of the reflectarray panel 255. The other region 280B of the radiating near field 280 is referred to as Fresnel region and defined as between

$$\sqrt{\frac{T}{2 λ}} \frac{T}{2} + λ$$

and

$$\frac{2 {T}^{2}}{λ} + λ .$$

To further elaborate on the above example where the reflectarray panel 255 with a side length of about 0.4 meter,

$$\sqrt{\frac{T}{2 λ}} \frac{T}{2} + λ$$

is determined to be 1.5 meter and

$$\frac{2 {T}^{2}}{λ} + λ$$

is determined to be 61 meter from the reflectarray panel 255, and the λ is determined to be 0.0107 meter as discussed above. The region farther than the Fresnel region 280B is defined as far field 290 for radiating field. The proceeding disclosures described with respect to subsequent figures are example implementations of the subject technology in accordance with various embodiments disclosed herein.

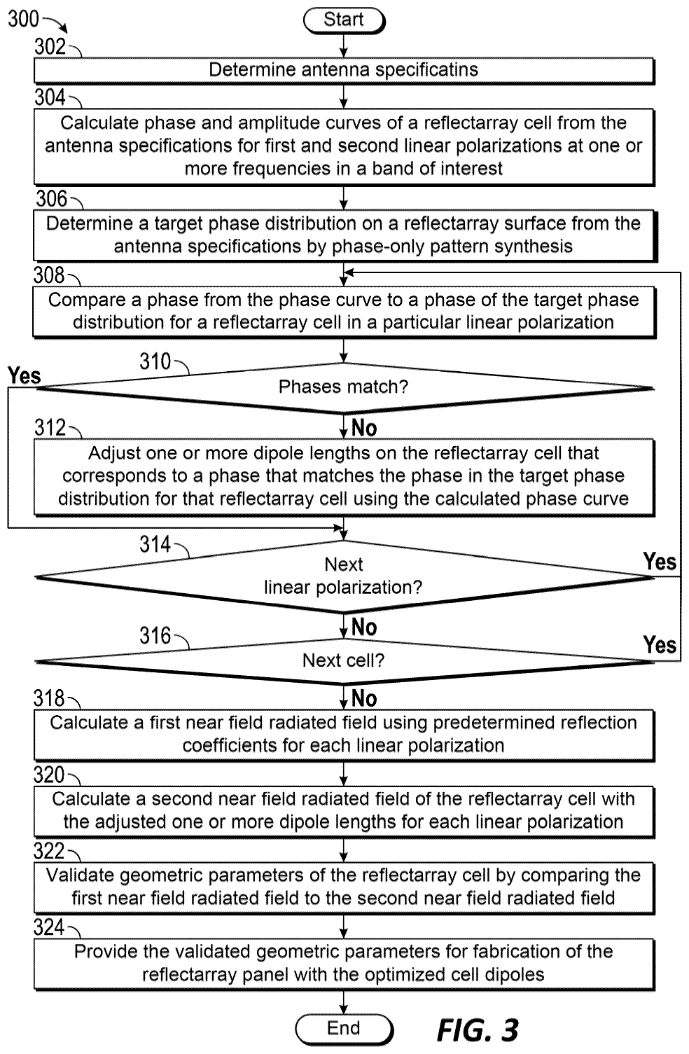

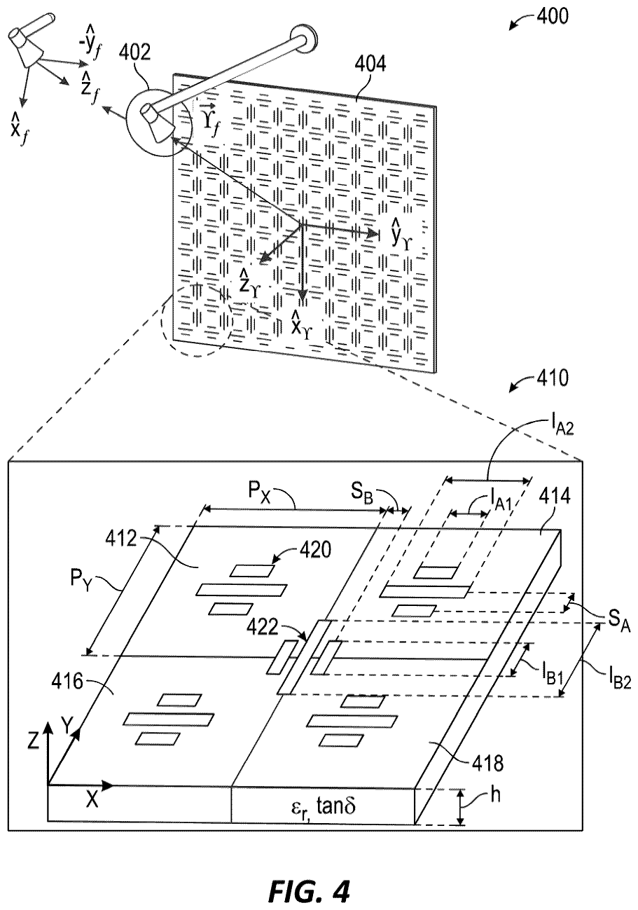

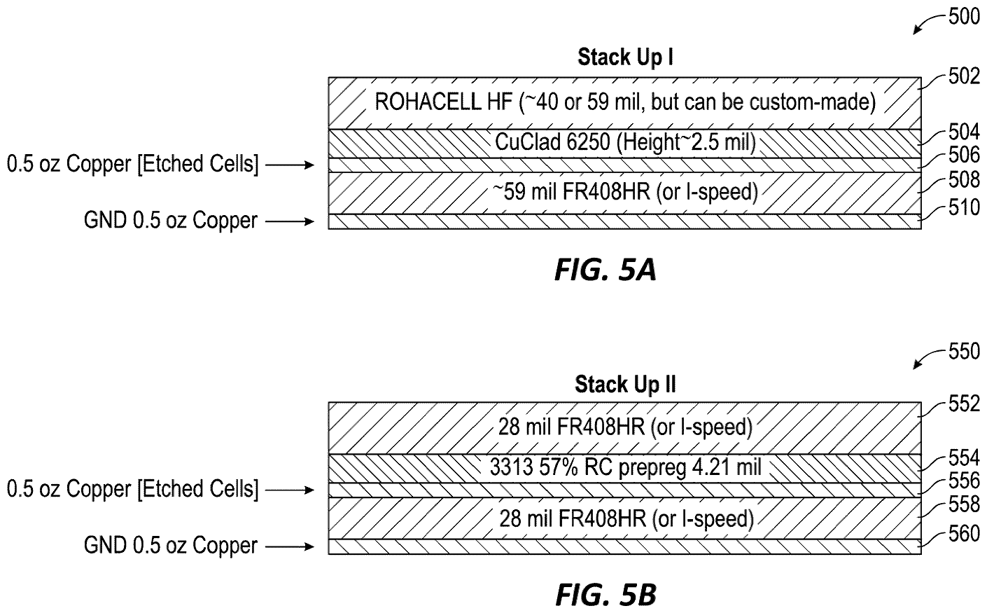

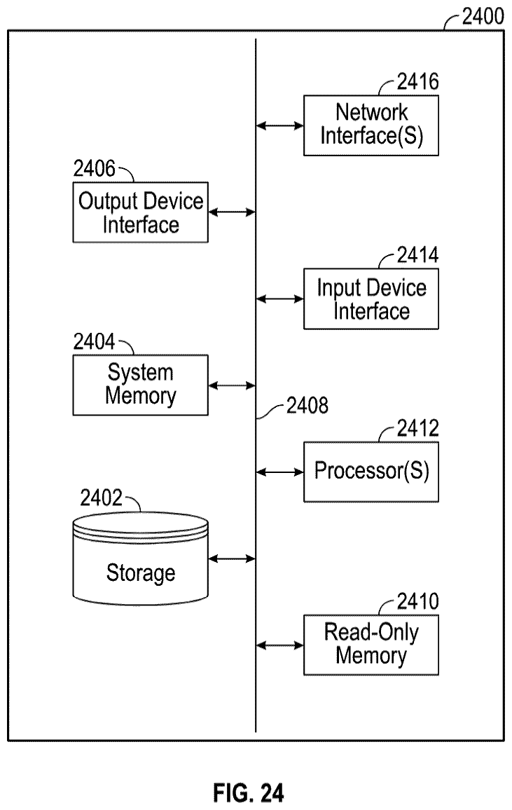

Attention is now directed to FIG. 3, which illustrates a flowchart of an example process 300 of designing a reflectarray panel for enhanced wireless communication coverage area, in accordance with various implementations of the subject technology. For explanatory purposes, the example process 300 is primarily described herein with reference to FIGS. 4, 5A-B, 6A-B, 7A-B, and to the electronic system 2400 of FIG. 24; however, the example process 300 is not limited to the electronic system 2400 of FIG. 24, and the example process 300 can be performed by one or more other components of the electronic system 2400 of FIG. 24. Further for explanatory purposes, the blocks of the example process 300 are described herein as occurring in serial, or linearly. However, multiple blocks of the example process 300 can occur in parallel. In addition, the blocks of the example process 300 can be performed in a different order than the order shown and/or one or more of the blocks of the example process 300 are not performed.

The example process 300 begins at step 302, where reflectarray specifications are determined. In some implementations, the antenna specifications may include information about the shape of the reflectarray, the number of elements in the reflectarray, the periodicity of the elements, the electrical properties of the materials, the aperture size of the reflectarray, the shape of the radiated beam in azimuth and elevation angles, the direction of the radiated beam, the distance between the reflectarray and the BS, the placement of the base station in Cartesian coordinates, the half-power beam width (HPBW) of the reflectarray, the working frequency, and so forth.

For explanatory purposes, the step of determining the antenna specifications will be discussed in reference to an example of a reflectarray configuration 400 as shown in FIG. 4. Attention is now directed to FIG. 4, which illustrates a schematic diagram of an example of a planar reflectarray antenna and a considered unit cell in accordance with various implementations of the subject technology. The reflectarray configuration 400 includes a reflectarray panel 404 that is illuminated by a feed 402 generating an incident electric field on its surface. The feed 402 may be a base station (BS) with a wireless radio in some implementations or may be a horn antenna in other implementations. In some examples, the reflectarray antenna 404 is rectangular and comprised of about 7,744 elements in a rectangular grid of 88×88. In other examples, the reflectarray antenna 404 is comprised of about 4,356 elements in a rectangular grid of 66×66. The reflectarray antenna 400 may include a different shape with a grid having a different number of elements from that illustrated in FIG. 4 without departing from the scope of the present disclosure. The feed 402 may be placed a predetermined distance with regard to the center of the reflectarray antenna 404. In some implementations, the feed 402 may be modeled as a cos^{q} θ function.

The cutout 410 shown in FIG. 4 includes a subarray of cells, namely cells 412, 414, 416 and 418. Each cell is comprised of a patterned layer that includes a set of multiple parallel dipoles for each linear polarization. The length (along the x-axis) and width (along the y-axis) of each cell is depicted as P_{X} and P_{Y}, respectively. The length may be in a range of 3.0 mm to 5.0 mm, and the width may be in a range of 3.0 mm to 5.0 mm. The periodicity of the cells within the cutout 410 is in a range of 3.0 mm to 5.0 mm in both axes (e.g., x, y), which is less than half a wavelength at a working frequency of about 28 GHz to avoid grating lobes. The working frequency is in a range of 27.5 GHz to 28.5 GHz, and more particular, at a center frequency of about 28 GHz.

The separation between dipoles is set to S_{A} for separations along the y-axis and S_{B} for separations along the x-axis. In some implementations, the separation (S_{A}, S_{B}) may be set in a range of 0.4 mm to 1.1 mm, depending on the dimensions of the dipoles. The cutout 410 includes a first element type with dipoles that extend laterally along the x-axis (e.g., 420), and a second element type with dipoles that extend laterally along the y-axis (e.g., 422). In some implementations, each element type includes two parallel dipoles with a first length (denoted as I_{A1}, I_{B1}) and one dipole with a second length (denoted as I_{A2}, I_{B2}) that is interposed between the two first-length dipoles in a parallel arrangement. In some implementations, the second length is greater than the first length, such that the first length is a predetermined fraction of the second length. For example, the predetermined fraction is set to a fraction value that is in a range of 0.5 to 0.8. The width of each of the dipoles may be in a range of 0.2 mm to 0.4 mm. The cutout 410 includes the first element type in each of the cells 412, 414, 416 and 418, and the second element type located at a center of the cutout 410 that is centered between the cells 412, 414, 416 and 418. In some implementations, the arrangement of the first element type (e.g., 420) is orthogonal to that of the second element type (e.g., 422), in which the first element type runs parallel to the x-axis and the second element type runs parallel to the y-axis. As depicted in FIG. 4, the cutout 410 includes a single substrate layer with a relative permittivity, εᵣ, that is in a range of 3.64 to 3.72 and a loss tangent, δ, in a range of 0.0072 to 0.0095, at the working frequency. In some examples, the substrate layer has a thickness (or height, h) in a range of 0.254 mm (or 10 mils) to 1.524 mm (or 60 mils).

Attention is now directed to FIGS. 5A and 5B, which illustrate schematic diagrams with cross-sectional views of different reflectarray antenna stack-up configurations in accordance with various implementations of the subject technology. In some implementations, the substrate layer depicted in FIG. 4 may correspond to, or at least a portion of, one of the stack-up configurations depicted in FIGS. 5A and 5B. FIG. 5A illustrates a cross-sectional view of a first stack-up configuration 500, and FIG. 5B illustrates a cross-sectional view of a second stack-up configuration 550. Not all of the depicted components may be used, however, and one or more implementations may include additional components not shown in the figure. Variations in the arrangement and type of the components may be made without departing from the scope of the claims set forth herein. Additional components, different components, or fewer components may be provided.

In FIG. 5A, the first stack-up configuration 500 includes superstrate 502, bonding layer 504, substrate 508 and conductive layers 506 and 510. In some implementations, the superstrate 502 has a dielectric constant=1.1 and loss tangent=0.003, at 10 GHz, which corresponds to commercially available ROHACELL HF71, and with a thickness in a range of 0.508 mm (or 20 mils) to 1.524 mm (or 60 mils). The bonding layer 504 is a pre-impregnated composite material that includes an ethylene-acrylic acid thermoplastic copolymer, with a dielectric constant=2.32 and a loss tangent=0.0013, at 10 GHz, which corresponds to commercially available CuClad 6250, and with a thickness of about 0.064 mm (or about 2.5 mils). In some implementations, the substrate 508 has a dielectric constant=3.65 and loss tangent=0.0125, at 10 GHz, which corresponds to commercially available ISOLA FR408, and with a thickness of about 1.5 mm (or 59 mils). In some implementations, the conductive layers 506 and 510 include a Copper density lesser than 1.0. In some implementations, the conductive layer 506 is a patterned layer that serves as a signal plane and the conductive layer 510 serves as a ground plane.

In FIG. 5B, the second stack-up configuration 550 includes superstrate 552, bonding layer 554, substrate 558 and conductive layers 556 and 560. In some implementations, the superstrate 552 and the substrate 558 include a same material, in which each layer has a dielectric constant=3.65 and loss tangent=0.0125, at 10 GHz, which corresponds to commercially available ISOLA FR408, and with a thickness of about 0.711 mm (or 28 mils). The bonding layer 554 is a pre-impregnated composite material with a dielectric constant=3.6 and a loss tangent=0.001, at 10 GHz, with a thickness of about 0.1 mm (or 4 mils). In some implementations, the conductive layers 556 and 560 include a Copper density lesser than 1.0. In some implementations, the conductive layer 556 is a patterned layer that serves as a signal plane and the conductive layer 560 serves as a ground plane.

Referring back to FIG. 3, at step 304, phase and amplitude curves of a reflectarray cell are calculated as a function of the dipole lengths in the reflectarray cell from the antenna specifications for first and second linear polarizations at one or more frequencies in a band of interest. For example, the first and second linear polarizations correspond to the X polarization and Y polarization, respectively. The band of interest may correspond to frequencies applicable to 5G wireless communications in the millimeter band, such as a range of 27.2 GHz to 28.2 GHz with a center frequency at about 27.7 GHz in some implementations, or a range of 27.5 GHz to 28.5 GHz with a center frequency at about 28.0 GHz. The phase and amplitude curves may be obtained at a central frequency, including at threshold frequencies. The phase and amplitude curves may illustrate the phase shift produced by a reflectarray element as well as the signal losses, as a function of the dipole lengths.

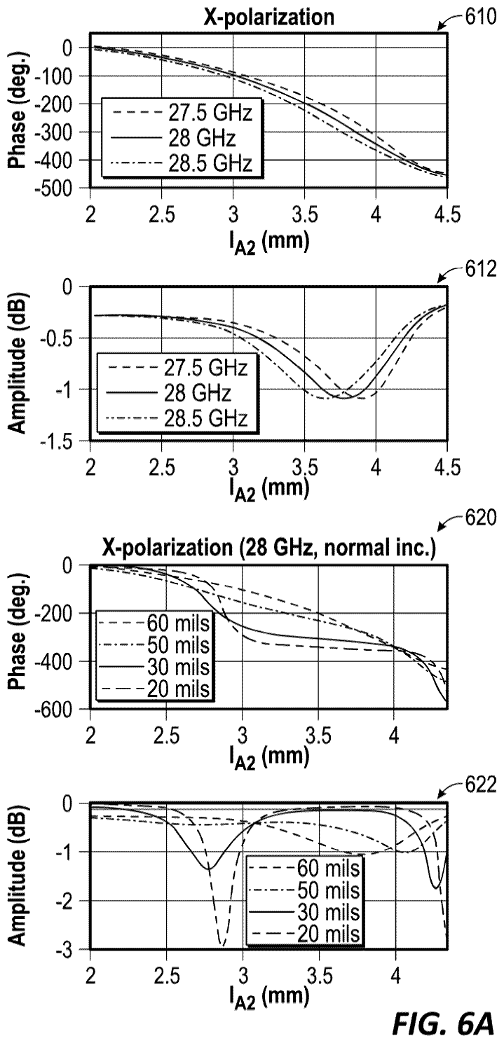

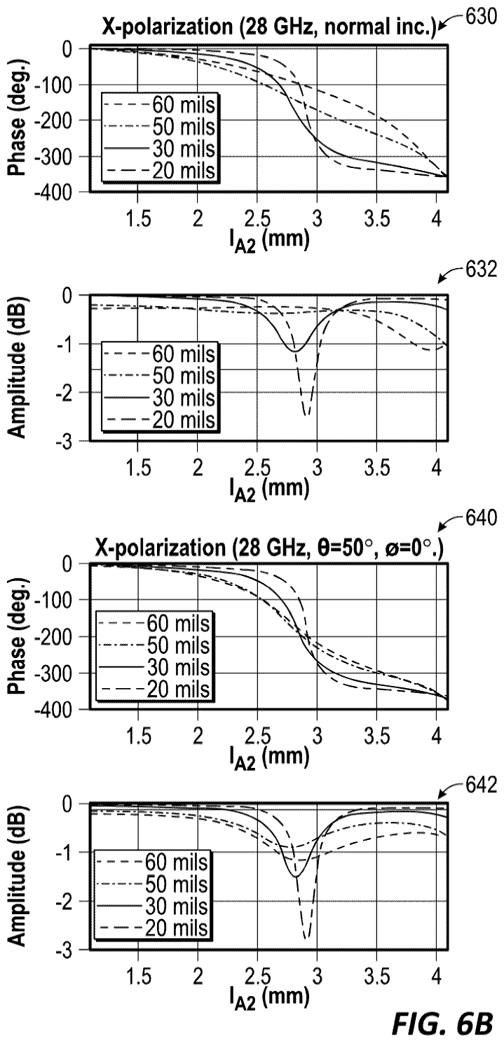

Attention is now directed to FIGS. 6A and 6B, which illustrate plot diagrams of phase and amplitude curves as a function of the dipole length for the X-polarization. The plots in FIGS. 6A and 6B are generated based on the cell geometric parameters and substrate properties. In FIG. 6A, for example, the cell periodicity is set to 5.0 mm with the dipole length I_{A1}=0.6*I_{A2} and dipole width=0.4 mm, and dipole separations set to 1.1 mm. The substrate layer has a dielectric constant=3.65 and loss tangent=0.0095. The phase and amplitude response of the reflectarray cell is analyzed in an infinite periodic array environment for a linearly polarized plane wave impinging at a normal incidence angle at the working frequency of 28 GHz. Plot 610 depicts three phase curves as a function of the I_{A2} dipole length for three frequencies, 27.5 GHz, 28 GHz, 28.5 GHz, respectively. Plot 612 depicts three amplitude curves as a function of the I_{A2} dipole length for the same three frequencies, 27.5 GHz, 28 GHz, 28.5 GHz, respectively. As can be observed, the phase curves of plot 610 show a phase range of about 400 degrees over a dipole length range of 2.0 mm to 4.5 mm. Similarly, the amplitude curves in the plot 612 show the amplitude losses corresponding to the dipole length range of 2.0 mm to 4.5 mm. With this information, the corresponding dipole length that achieves the desired phase shift can be determined.

In some implementations, the phase and amplitude are impacted by the substrate thickness. Plot 620 depicts four phase curves as a function of the I_{A2} dipole length for different substrate thicknesses, namely 20 mils, 30 mils, 50 mils and 60 mils. For example, the phase transitions more smoothly for substrate thicknesses 50 mils, 60 mils compared to substrate thicknesses 20 mils, 30 mils. In this respect, plot 622 depicts four amplitude curves for the corresponding substrate thicknesses, where the amplitude losses are greater at a dipole length of about 3.0 mm when the substrate thickness is set to about 20 mils, 30 mils compared to the other substrate thicknesses 50 mils, 60 mils.

In FIG. 6B, the cell periodicity is set to 4.5 mm instead of 5.0 mm, and the reflectarray cell is analyzed in an infinite periodic array environment for a linearly polarized plane wave impinging at a normal incidence angle at the working frequency of 28 GHz. Plot 630 depicts four phase curves as a function of the I_{A2} dipole length for different substrate thicknesses, namely 20 mils, 30 mils, 50 mils and 60 mils. In this example, the phase transitions more smoothly for substrate thicknesses 50 mils, 60 mils compared to substrate thicknesses 20 mils, 30 mils. The phase shift varies more significantly at about 3.0 mm for the substrate thickness lesser than 30 mils. Plot 632 depicts four amplitude curves for the corresponding substrate thicknesses, where the amplitude losses are greater at a dipole length of about 3.0 mm when the substrate thickness is set to about 20 mils, 30 mils compared to the other substrate thicknesses 50 mils, 60 mils. In comparison to plot 642, the amplitude losses in plot 632 appear smaller for the substrate thickness of 20 mils. Plots 640 and 642 respectively depict phase and amplitude curves when the incident plane wave is set to an azimuth angle of 0 degrees and elevation angle of 50 degrees. In comparison to plots 630 and 632, the phase curve in plot 640 appears to show the phases varying faster for substrate thicknesses 50 mils, 60 mils, and the amplitude losses are more prevalent in plot 642 for substrate thicknesses 50 mils, 60 mils at the corresponding dipole lengths.

Referring back to FIG. 3, at step 306, a target phase distribution on a reflectarray surface is determined from the antenna specifications by phase-only pattern synthesis. Although designing reflectarray antennas for high-gain pencil beam patterns at a certain direction may be determined with analytical equations, the pattern synthesis of noncanonical beams is challenging and requires the use of an optimization algorithm in applications with tight specifications, such as in 5G wireless applications. The phase-only pattern synthesis at step 306 provides for pattern optimization of reflectarray antennas for 5G wireless communications, including co-polar and crosspolar specifications. In some implementations, the pattern synthesis is based on the use of a generalized Intersection Approach (IA) algorithm for the optimization of the reflectarray cell. In some implementations, the pattern synthesis of the subject technology is partitioned into two stages. First, a phase-only synthesis approach is performed with the IA algorithm, to obtain a phase shift distribution that generates a desired shaped radiation pattern. Secondly, the layout of the reflectarray antenna is obtained by adjusting the dimensions of each cell (e.g., modifying the dipole lengths in each cell).

In the subject technology, the reflectarray cells are optimized to provide the same phase-shift for both linear polarizations for large angles of incidence. In this respect, the pattern synthesis is performed to obtain two phase-shift distributions, one for each linear polarization. In some implementations, the same phase-shift distribution can be used for both linear polarizations.

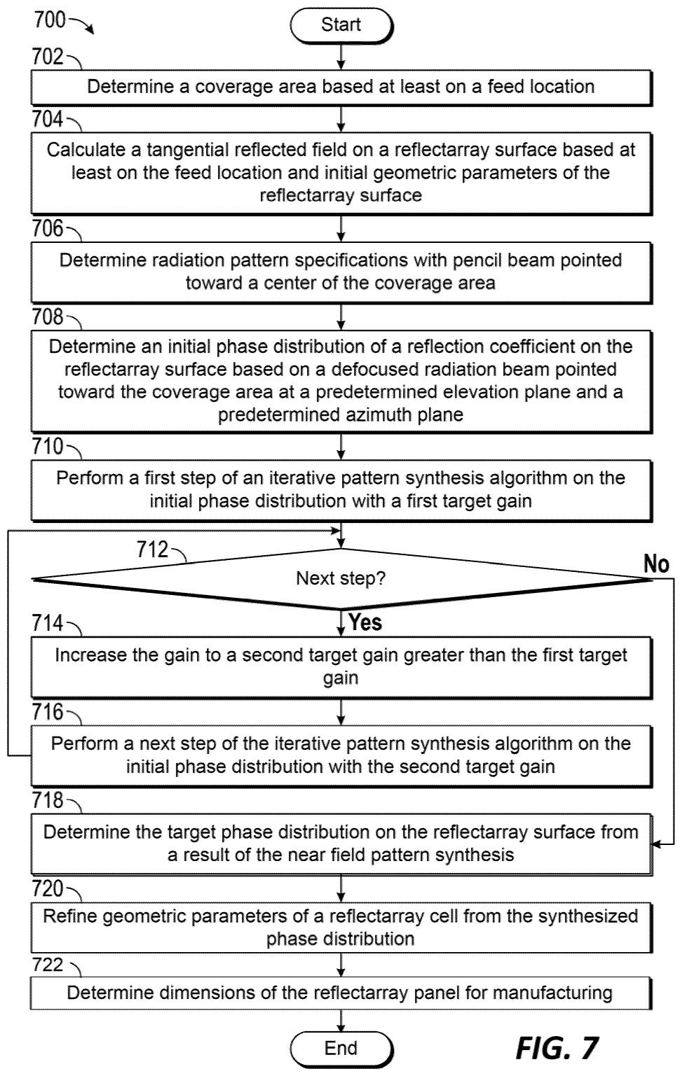

Attention is now directed to FIG. 7, which illustrates a flowchart of an example process 700 for performing the phase-only near-field pattern synthesis described at step 306 of FIG. 3 to optimize a reflectarray antenna design, in accordance with various implementations of the subject technology. For explanatory purposes, the example process 700 is primarily described herein with reference to the electronic system 2400 of FIG. 24; however, the example process 700 is not limited to the electronic system 2400 of FIG. 24, and the example process 700 can be performed by one or more other components of the electronic system 2400 of FIG. 24. Further for explanatory purposes, the blocks of the example process 700 are described herein as occurring in series, or linearly. However, multiple blocks of the example process 700 can occur in parallel. In addition, the blocks of the example process 700 can be performed in a different order than the order shown and/or one or more of the blocks of the example process 700 are not performed.

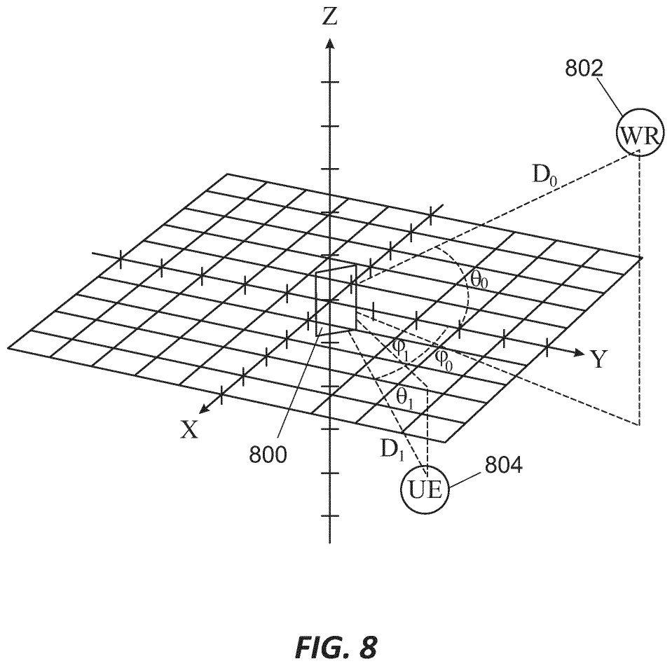

The example process 700 begins at step 702, where a coverage area is determined based at least on the feed location. In accordance with various embodiments herein, the BS is acting as a feed to the reflectarray panel. This step involves determining the geometry setup of the BS relative to the UE. The geometry setup includes the position of the BS within the wireless network, including its distance from the reflectarray panel, and the orientation and position of the reflectarray panel itself. Attention is now directed to FIG. 8, which illustrates the geometry setup of a BS 802 located at Do from a Cartesian (x, y, z) coordinate system positioned in the center of a reflectarray panel 800. The reflectarray panel 800 is positioned along the x-axis with the y-axis indicating its boresight. The BS 802 has an elevation angle θ₀ and an azimuth angle φ₀. Note that determining the geometry setup is a simple procedure involving simple geometrical tools such as, for example, a laser distance measurer and an angles measurer. This highlights the ease of setup of reflectarray panel 800 and further incentivizes its use when its significant wireless coverage and performance improvements are achieved at low cost with a highly manufacturable reflectarray that can be easily deployed in any 5G wireless environment, whether indoors or outdoors. The reflectarray panel 800 can be used to reflect incident RF waves from UE within the 5G network served by BS 802 that acts as a feed, such as, for example, UE 804 located at a distance D₁ from the reflectarray antenna 800 with θ₁ elevation and φ₁ azimuth angles.

Referring back to FIG. 7, at step 704, a tangential reflected field on a reflectarray surface is calculated based at least on the BS location and initial geometric parameters of the reflectarray surface. The pattern synthesis in near-field of the subject technology is an iterative algorithm that performs two operations at each iteration, i, on the tangential reflected field, so the working principle of the algorithm can be described as:

$${\vec{E}}_{ref , i + 1} = [ ( {\vec{E}}_{ref , i} ) ] , \qquad Eq . ( 1 )$$

where [symbol] is the forward projector (which projects the radiated field by the antenna onto a set of fields that comply with the coverage specifications, [symbol] is the backward projector (which projects the field that complies with the coverage specifications onto the set of fields that can be radiated by the antenna, and \vec{E}_{ref} is the tangential reflected field on the reflectarray surface. Referring back to FIG. 4, the reflectarray antenna 404 is illuminated by the feed 402, generating an incident electric field on its surface. The tangential reflected field on the reflectarray surface at each reflectarray element can be expressed as:

$${E}_{ref}^{X / Y} ( {x}_{l} , {y}_{l} ) = {R}^{l} \cdot {\vec{E}}_{i n c}^{X / Y} ( {x}_{l} , {y}_{l} ) , \qquad Eq . ( 2 )$$

where R^{l} is the reflection coefficient matrix, (xₗ,yₗ) are the coordinates of the center of the reflectarray element l, \vec{E}_{inc}^{X/Y}(xₗ, yₗ) is the fixed incident field impinging from the feed. The components of matrix R^{l} are complex numbers that fully characterize the electromagnetic behavior of the reflectarray cell. The reflection coefficient matrix takes the form:

$${R}^{l} = ( \begin{matrix}{ρ}_{xx}^{l} & {ρ}_{x y}^{l} \\ {ρ}_{yx}^{l} & {ρ}_{yy}^{l}\end{matrix} ) , \qquad Eq . ( 3 )$$

where ρₓₓ^{l} and ρ_{yy}^{l} are known as direct coefficients, while ρ_{xy}^{l} and ρ_{yx}^{l} are known as the cross-coefficients. The co-polar pattern may depend on the direct coefficients, and the crosspolar pattern depends on all coefficients. In some implementations, the coefficients are computed with a full-wave analysis tool assuming local periodicity.

Subsequently, at step 706, the algorithm starts with a pencil beam focused towards the center of the coverage area. In this respect, the initial phase distribution for the pattern synthesis may be obtained analytically for a collimated beam in the direction (φ₀, ϑ₀), which can be expressed as follows:

$$∠ ρ ( {x}_{l} , {y}_{l} ) = {k}_{0} ( {d}_{l} - ( {x}_{l} cos {φ}_{0} + {y}_{l} sin {φ}_{0} ) sin {θ}_{0} ) , \qquad Eq . ( 5 )$$

where ∠ρ(xₗ,yₗ) is the phase of a direct reflection coefficient (ρₓₓ or ρ_{yy}, for linear polarizations X and Y, respectively), dₗ is the distance from the BS to the lth element (see 410 of FIG. 4), and (φ₀,θ₀) is the pointing direction of the focused or collimated beam. In some implementations, the angle (φ₀,θ₀) is selected in a direction where the desired shaped beam has relatively high gain.

As part of the radiation pattern optimization, radiation pattern specifications are imposed in the co-polar and crosspolar components. When performing the pattern synthesis of the subject technology, only the co-polar requirements are considered due to the simplification in the analysis of the reflectarray cell. In the IA algorithm, the co-polar specifications are represented by two mask templates, namely the minimum (Tₘᵢₙ) and maximum (Tₘₐₓ) values, which are the minimum and maximum thresholds between which the co-polar radiation pattern is expected to lie. In this respect, the co-polar gain, G_{cp}, relative to the mask thresholds can be expressed as follows:

$${T}_{min} ( u , v ) \leq {G}_{c p} ( u , v ) \leq {T}_{max} ( u , v ) , \qquad Eq . ( 4 )$$

where u=sin θ cos φ and v=sin θ sin φ are the angular coordinates where the far field is computed.

For near field applications, such as for the Fresnel region described in FIG. 2B, the coordinate can be defined in Cartesian coordinate system where the position of a point (x, y, z) in the space is defined by the vector \vec{r}=x·\hat{x}+y·ŷ+z·\hat{z}, where \hat{x}, ŷ, \hat{z} are the unit vectors in x, y and z directions, with the origin of the coordinate system placed at the center of the reflectarray antenna surface. In doing so, the masks in near field can be expressed as follows:

$${T}_{min} ( x , y , z ) \leq {\vert \vec{E} ( x , y , z ) \vert}^{2} \leq {T}_{max} ( x , y , z ) , or \qquad Eq . ( 4 ’ )$$

$${T}_{min} ( \vec{r} ) \leq {\vert \vec{E} ( \vec{r} ) \vert}^{2} \leq {T}_{max} ( \vec{r} ) , \qquad Eq . ( 4 ” )$$

where |\vec{E}(\vec{r})| is the amplitude of the electric field produced at the point r.

Next, at step 708, an initial phase distribution for the co-polar reflection coefficients on the reflectarray surface is determined based on a defocused radiating beam pointed toward the coverage area at a predetermined elevation plane and a predetermined azimuth plane.

In various implementations and embodiments, the reflectarray panel should broaden the beam in azimuth, elevation or both planes. In those cases, the phase distribution corresponding to a collimated beam (defined by Eq. 5) is not appropriated as the initial phase distribution to start the near-field pattern synthesis. Instead, an initial phase distribution that corresponds to a defocused beam pointed towards the direction where the desired shaped, is considered. The initial phase distribution that generates the defocused beam is obtained by adding a quadratic phase correction to the phase distribution for a collimated beam (Eq. 5) as follows:

$$∠ρ ( {x}_{1} , {y}_{1} ) = {k}_{0} ( {d}_{1} - ( {x}_{1} cos {φ}_{0} + {y}_{1} sin {φ}_{0} ) sin {θ}_{0} ) + {A}_{x} + {A}_{y} , \qquad Eq . ( 5 ’ )$$

$$where$$

$${A}_{x} = {k}_{0} * ( {∝}_{x} * {( {( {T}_{x} / 2 )}^{2} - {x}_{l}^{2} )}^{β x} ) , and \qquad Eq . ( 5 ” )$$

$${A}_{y} = {k}_{0} * ( {∝}_{y} * {( {( {T}_{y} / 2 )}^{2} - {y}_{l}^{2} )}^{β y} ) , \qquad Eq . ( 5 ’ ’ ’ )$$

where Tₓ and T_{y} are the dimensions of the entire reflectarray antenna in x and y, respectively, αₓ and α_{y} are coefficients that are adjusted to control de degree of broadening of the beam in x and y directions, respectively. The values of αₓ and α_{y} can vary from 0.0 to 0.5, producing a higher defocusing and broadening of the beam with larger values of coefficients αₓ and α_{y}. Note that when αₓ=0 and α_{y}=0, the phase in Eq. (5′) beam corresponds to a collimated beam. In addition, there are two additional adjusting coefficients, βₓ and β_{y}, to control the degree of variation of the phase correction, with typical values from 0.5 to 2. Note that when βₓ=1 and β_{y}=1, the phase correction is proportional to the square of the distance from the edges to the center of the reflectarray panel.

Subsequently, at step 710, a first step of an iterative pattern synthesis algorithm is performed on the initial phase distribution with a first target radiation pattern. In some implementations, each step of the iterative pattern synthesis algorithm includes performing the forward projection operation and the backward projection operation. In some implementations, the forward projection operation includes computing the radiation pattern of the far or near field, for both linear polarizations, and trimming the far or near field gain of the current gain radiated by the antenna. In some implementations, each step may perform a fixed number of iterations of the operations with the same parameters. In some implementations, the number of iterations performed may vary between steps, depending on implementation.

In some implementations, the reflectarray cell is modeled as an ideal phase shifter, where there are no losses (e.g., ρₓₓ^{l}=ρ_{yy}^{l}=1) and no element crosspolarization (e.g., ρ_{xy}^{l}=ρ_{yx}^{l}=0). Thus, the reflection coefficient matrix is simplified to:

$${R}^{l} = ( \begin{matrix}{e}^{( j {ϕ}_{x x}^{l} )} & 0 \\ 0 & {e}^{( j {ϕ}_{y y}^{l} )}\end{matrix} ) , \qquad Eq . ( 6 )$$

where ϕ^{l} is the phase of the corresponding reflection coefficient. In this respect, the tangential reflected field of each polarization is based on the phases of both direct coefficients, namely ϕₓₓ^{l} and ϕ_{yy}^{l}. Reflectarray antennas can be classified as planar apertures and the far fields can be determined by using the Fast Fourier Transform (FFT) algorithm. For example, the FFT computes the current far field radiated by the reflectarray antenna.

In some implementations, the co-polar component, for both linear polarizations, is obtained from the far field in spherical coordinates. Once the co-polar far field radiation pattern is obtained, the squared field amplitude or gain is computed. For example, the gain can be estimated by computing the total power radiated by the feed. The forward projection operation also includes trimming the far field gain according to the mask thresholds (e.g., Tₘᵢₙ(u,v)≤G_{cp} (u,v)≤Tₘₐₓ(u,v)). For example, if the current gain of the reflectarray antenna is greater than Tₘₐₓ, then G_{cp} is decreased to Tₘₐₓ, and conversely, if G_{cp} is lesser than Tₘᵢₙ, then G_{cp} is increased to Tₘᵢₙ. The result of the trimming operation by the forward projection operation is a modified far field that complies with the antenna specifications.

The backward projection operation minimizes the distance between the trimmed gain and the current gain radiated by the antenna, thus obtaining a tangential reflected field that generates a radiation pattern that is closer to satisfy the antenna specifications. Thus, the backward projection operation can be expressed as:

$${\vec{E}}_{ref , i + 1} = [ ( {\vec{E}}_{ref , i} ) ] = min dist [ Gi , ( {\vec{E}}_{ref , i} ) ] . \qquad Eq . ( 7 )$$

In some implementations, the latter operation is performed by a minimization algorithm, such as the Levenberg-Marquardt Algorithm (LMA). The optimization variables may be the phases of the reflection coefficients, ϕₓₓ for X polarization and ϕ_{yy} for Y polarization. In other implementations, a direct optimization layout can be performed with the IA algorithm, where the optimization variables represent the dipole lengths instead of the phases of the reflection coefficients. In some implementations, the two polarizations can be synthesized independently. In some implementations, the backward projection operation with the LMA may include, among others, performing a gradient computation with a Jacobian matrix (J) and performing a matrix multiplication (J^{T}J).

For near field applications, the computation of the electric field is slightly different and will be described below. For computation of the near field electric field \vec{E}(\vec{r}), the field is not computed using the FFT algorithm. Rather, the points of the coverage are in the near field of the reflectarray but in the far field of the reflectarray elements. The far field of the reflectarray elements can be summarized in a contribution and all of them contribute to each point in the space. For example, the electric near field of the reflectarray panel is computed as summation of the far field contributions of all the reflectarray elements, which can be expressed as:

$$\vec{E} ( \vec{r} ) = {\sum }_{l = 1}^{N e l e m} {\vec{E}}_{F F}^{l} ( {\vec{r}}_{l} ) , \qquad Eq . ( 8 )$$

where Nelem is a number of elements of the reflectarray antenna, l denotes each reflectarray antenna element and \vec{r}ₗ is the position of the point view from the element l. This can be further expressed as:

$${\vec{r}}_{l} = \vec{r} - {\vec{r}}_{l}^{′} , \qquad Eq . ( 9 )$$

where \vec{r}′ₗ is the position vector of the element l at the coordinates (xₗ, yₗ). This denotes the placement of the reflectarray antenna element for all antenna elements from the center of the reflectarray antenna, which is used as the origin of the coordinate system. For the position given by \vec{r}ₗ, an angular direction can be determined by this vector can be expressed in (θₗ, φₗ) or alternatively by (uₗ, vₗ) since uₗ=sin θₗ cos φₗ and vₗ=sin θₗ sin φₗ. Specifically, the electric field components θₗ and φₗ can be expressed as:

$${\vec{E}}_{FF , {θ}_{l}}^{l} ( {\vec{r}}_{l} ) = \frac{j {k}_{0} {e}^{- j {k}_{0} {r}_{l}}}{2 π {r}_{l}} ( {P}_{x}^{l} cos {φ}_{l} + {P}_{y}^{l} sin {φ}_{l} ) , and \qquad Eq . ( 10 )$$

$${\vec{E}}_{FF , {φ}_{l}}^{l} ( {\vec{r}}_{l} ) = - \frac{j {k}_{0} {e}^{- j {k}_{0} {r}_{l}}}{2 π {r}_{l}} cos {θ}_{l} ( {P}_{x}^{l} sin {φ}_{l} - {P}_{y}^{l} cos {φ}_{l} ) , \qquad Eq . ( 11 )$$

where rₗ is the modulus of \vec{r}ₗ and denotes the distance from the reflectarray element to the point, k₀ is the wave number in vacuum and is computed as 2πf/c₀ (c₀ is the light velocity in vacuum and f is the frequency), and Pₓ^{l} and P_{y}^{l} are the spectrum functions of the x and y components, respectively. Equations 10 and 11 can be combined and rewritten in spherical components as:

$${\vec{E}}_{F F}^{l} ( {\vec{r}}_{l} ) = {E}_{FF , {θ}_{l}}^{l} ( {\vec{r}}_{l} ) \hat{θ} + {E}_{FF , {φ}_{l}}^{l} ( {\vec{r}}_{l} ) \hat{φ} . \qquad Eq . ( 12 )$$

However, in order to sum all the contributions from each of the reflectarray antenna elements of the reflectarray panel, the electric field expression can be rewritten in cartesian coordinate system and in cartesian components as:

$${\vec{E}}_{F F}^{l} ( {\vec{r}}_{l} ) = {E}_{F F , {x}_{l}}^{l} ( {\vec{r}}_{l} ) \hat{x} + {E}_{FF , {y}_{l}}^{l} ( {\vec{r}}_{l} ) \hat{y} + {E}_{F F , {z}_{l}}^{l} ( {\vec{r}}_{l} ) \hat{z} . \qquad Eq . ( 13 )$$

Such transformation of spherical coordinates to cartesian coordinates can be performed, after which the summations of contributions from each reflectarray antenna element for all points can be performed.

Furthermore, a spectrum function of the reflectarray can be computed as follows. For example, a general spectrum function can be determined by integrating the electric field on the surface of the reflectarray element Sᵢ according to the following equation:

$$P ( u , v ) = \int {\int }_{{S}_{i}} {E}_{r e f} ( x , y ) {e}^{j {k}_{0} ( u x + v y )} d xdy , \qquad Eq . ( 14 )$$

where E_{ref} is the reflected field on the surface of the reflectarray antenna. If the reflected field is assumed to be constant, the integration can be rewritten as:

$$P ( u , v ) = {E}_{r e f} \int {\int }_{{S}_{i}} {e}^{j {k}_{0} ( u x + v y )} d x d y = {E}_{r e f} \cdot a \cdot b \cdot sinc ( \frac{{k}_{0} u a}{2} ) sinc ( \frac{{k}_{0} v b}{2} ) , \qquad Eq . ( 15 )$$

where a and b are the dimensions of the reflectarray antenna element in x and y directions, respectively. In such implementations, the spectrum functions for a given angular direction (θ,) can be expressed as:

$${P}_{x} ( u , v ) = {E}_{ref , x} \cdot a \cdot b \cdot sinc ( \frac{{k}_{0} u a}{2} ) sinc ( \frac{{k}_{0} v b}{2} ) , \qquad Eq . ( 16 )$$

$${P}_{y} ( u , v ) = {E}_{ref , y} \cdot a \cdot b \cdot sinc ( \frac{{k}_{0} u a}{2} ) sinc ( \frac{{k}_{0} v b}{2} ) , \qquad Eq . ( 17 )$$

where u=sin θ cos φ and v=sin θ sin φ, E_{ref,x} and E_{ref,y} are the components x and y of the electric field at the center of the reflectarray antenna.

Next, at step 712, a determination is made as to whether a next step of the iterative pattern synthesis algorithm is available. If a next step of the algorithm is available, then the process 700 proceeds to step 714. Otherwise, the process 700 proceeds to step 718. In some implementations, the pattern synthesis algorithm includes determining a convergence of the algorithm as to whether another step of the algorithm is available. In this respect, if the algorithm does not converge, then the process 700 proceeds to step 714.

At step 716, a next step of the iterative pattern synthesis algorithm is performed on the initial phase distribution with the second target gain. At the conclusion of step 716, the process 700 proceeds back to step 712 to determine whether a next step is available.

At step 718, the target phase distribution on the reflectarray surface is determined from a result of the pattern synthesis. As used herein, the term “target phase distribution” may refer to the term “synthesized phase distribution” to denote its relation to the pattern synthesis, and the term can be used interchangeably without departing from the scope of the present disclosure.

Referring back to FIG. 3, at step 308, a phase from the phase curve is compared to a phase of the target phase distribution for a reflectarray cell in a particular linear polarization. Subsequently, at step 310, the determination is made as to whether the compared phases match. If the phases do match, the process 300 proceeds to step 314. Otherwise, the process 300 proceeds to step 312.

At step 312, one or more dipole lengths on the reflectarray cell that correspond to a phase that matches the phase in the target phase distribution is adjusted for that reflectarray cell using the calculated phase curve. Referring back to FIG. 7, at step 720, geometric parameters of a reflectarray cell are refined from the synthesized phase distribution. For example, the dipole lengths of each reflectarray cell are adjusted such that the phase shift provided by that element matches the corresponding phase shift represented in the synthesized phase distribution. In some implementations, a linear equation is used to approximate the value of the dipole size that provides the required phase shift. Once step 720 is complete, the next step is to determine dimensions of the reflectarray panel for manufacturing, at step 722.

Next, at step 314, the determination is made as to whether a next linear polarization exists. If a next linear polarization exists, the process 300 proceeds back to step 308. Otherwise, the process 300 proceeds to step 316. In some implementations, the dipole length adjustments are performed independently for the two linear polarizations. For example, the initial dipole length adjustments made in step 312 may have been directed to X polarization, and step 314 determines that dipole length adjustments in Y polarization are needed, and vice versa.

At step 316, the determination is made as to whether a next reflectarray cell exists. If a next reflectarray cell exists, the process 300 proceeds back to step 308. Otherwise, the process 300 proceeds to step 318. Here, if all reflectarray cells have been processed, then the process 300 proceeds to step 318 to determine a final reflectarray antenna layout that generates the desired shaped radiation pattern.

Subsequently, at step 318, a first radiation pattern of the reflectarray antenna using predetermined reflection coefficients is calculated for each linear polarization. For example, the first radiation pattern may be generated using the analytical representation of the radiated far fields at Eqs. 7-10. Next, at step 320, a second radiation pattern of the reflectarray antenna with the adjusted one or more dipole lengths is calculated for each linear polarization. The second radiation pattern may be generated by performing the FFT operation on the synthesized phase distribution. In some implementations, the second radiation pattern may include the co-polar component of the far field and/or the crosspolar component of the far field, in the u-v plane for the whole visible region.

Subsequently, at step 322, geometric parameters of the reflectarray antenna are validated by comparing the first radiation pattern to the second radiation pattern. In some implementations, the two radiation patterns may be compared to determine any differences in gain and/or losses. In some implementations, main cuts in elevation and azimuth for both linear polarizations along with mask thresholds are obtained to better determine how the specifications are met. In some implementations, the Side Lobe Level (SLL) can be observed relative to the minimum and maximum threshold levels.

Next, at step 324, the validated geometric parameters are provided to fabricate the reflectarray panel, where each cell is fabricated with the optimized dipole lengths and cell geometric parameters, which yields the target phase distribution for both linear polarizations. In some implementations, the reflectarray antenna design with validated geometric parameters are provided by an electronic device (see FIG. 24) through a network interface of the electronic device, over a network, to another electronic device that executes one or more fabrication processes.

Once the reflectarray is fabricated, it is ready for placement and operation to significantly boost the wireless coverage and performance of any 5G or other wireless application, whether indoors or outdoors. Note that even after the design is completed and the reflectarray is manufactured and placed in an environment to enable high performance wireless applications, the reflectarray can still be adjusted with the use of say rotation mechanisms attached to the reflectarray. In addition to many configurations, the reflectarrays disclosed herein can generate a focused, directed narrow beam to improve wireless communications between UE and a BS serving the UE in a wireless network. The reflectarrays are low cost, easy to manufacture and set up, and may be self-calibrated without requiring a 5G or wireless network operator to adjust its operation. They may be passive (or active with an integrated transmitter) and achieve MIMO like gains and enrich the multipath environment. It is appreciated that these reflectarrays effectively enable the desired performance and high speed data communications promises of 5G.

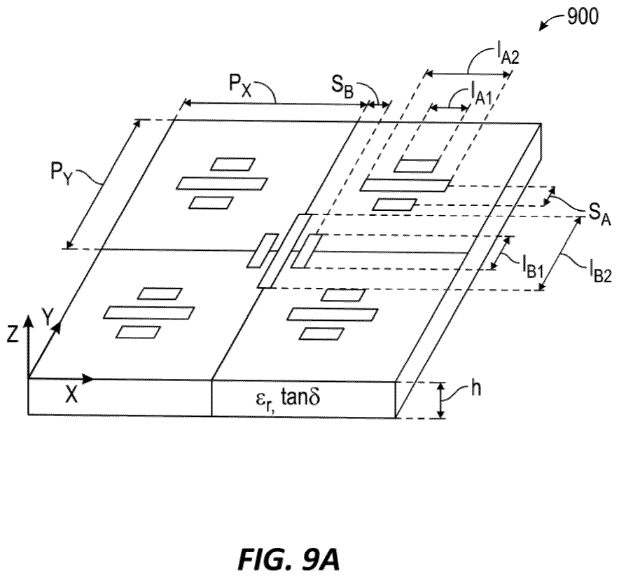

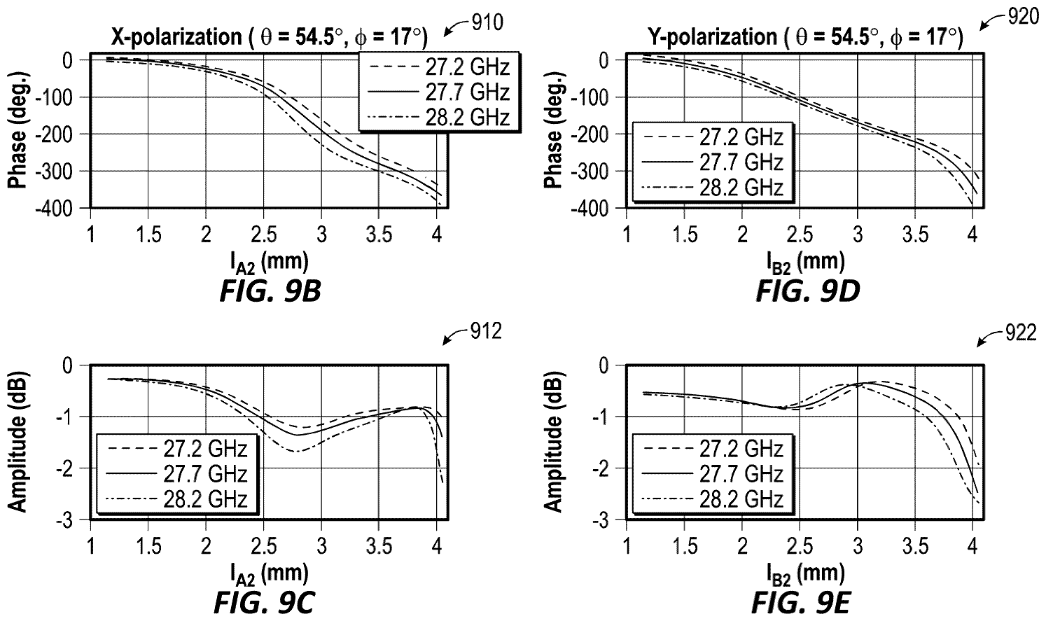

FIGS. 9A-9E illustrate plot diagrams of phase and amplitude curves as a function of the dipole length for the X- and Y-polarizations for a given reflectarray cell (e.g., the reflectarray configuration 400 of FIG. 4) in accordance with various implementations of the subject technology. In this example, the considered reflectarray antenna is rectangular and comprised of 31,684 cells (178 elements in the main axes). The periodicity is 4.5 mm in both axes, which is less than half a wavelength at the working frequency of 27.7 GHz, in order to minimize (or avoid) grating lobes. The feed (or base station) can be placed at (−33.5, −10.3, 24.9) m with regard to the center of the reflectarray with a distance of 43 m between the feed and the reflectarray antenna. The reflectarray configuration 400 has a separation of about 0.7 mm between dipoles, while the width of all dipoles is about 0.25 mm. The dipole lengths are set to L_{A1}(L_{B1})=0.65*L_{A2}(L_{B2}). Regarding the far field specifications, the selected pattern for a 5G base station has a squared cosecant beam in azimuth and a sectored beam in elevation to provide constant power flux in an azimuth span. The beam is pointed at an elevation angle of 16° and an azimuth angle of 0°. This direction may correspond to a region of the specification that masks with high gain. In FIGS. 9A and 9B, the plots 910 and 912 respectively show the phase and amplitude curves of the reflectarray cell for the X-polarization, assuming an infinite periodic array model and oblique incidence of a linearly polarized plane wave impinging at angles (θ=54.5°, ϕ=17°), which correspond to the incidence angles from the feed (or base station) on the center of the reflectarray antenna. In FIGS. 9C and 9D, the plots 920 and 922 respectively show the phase and amplitude curves of the reflectarray cell for the Y-polarization, obtained under the same conditions than those shown in the plots of FIGS. 9A and 9B.

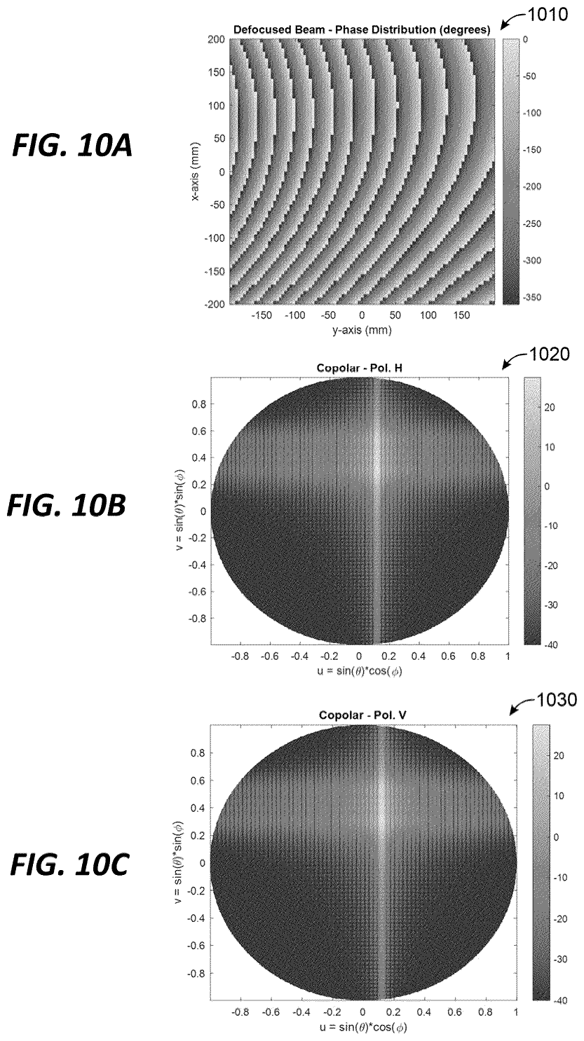

FIGS. 10A-10C illustrate phase distribution and far field radiation patterns using a defocused beam of a reflectarray in accordance with various implementations of the subject technology. As illustrated in FIG. 10A, plot 1010 represents the synthesized phase distribution that is output from the far field pattern synthesis operation. In some implementations, the plot 1010 shows the phase distribution as a function of x-axis and y-axis, which define the reflectarray surface, and where the broadening is observed in the azimuth (x-direction), and in this direction and also in elevation (y-direction). This is further illustrated in FIGS. 10B and 10C, where the 3-dimensional far field radiation patterns shown in plots 1020 and 1030 using the defocused beam are plotted in the polarization directions H and V. As illustrated, the 3-dimensional far field radiation patterns show how the beams are anisotropic and that they are broadened in the azimuth plane (v-axis), but not in the vertical plane (u-axis). The beam is tilted in both azimuth and elevation planes since the boresight direction is defined by (u,v)=(0,0).

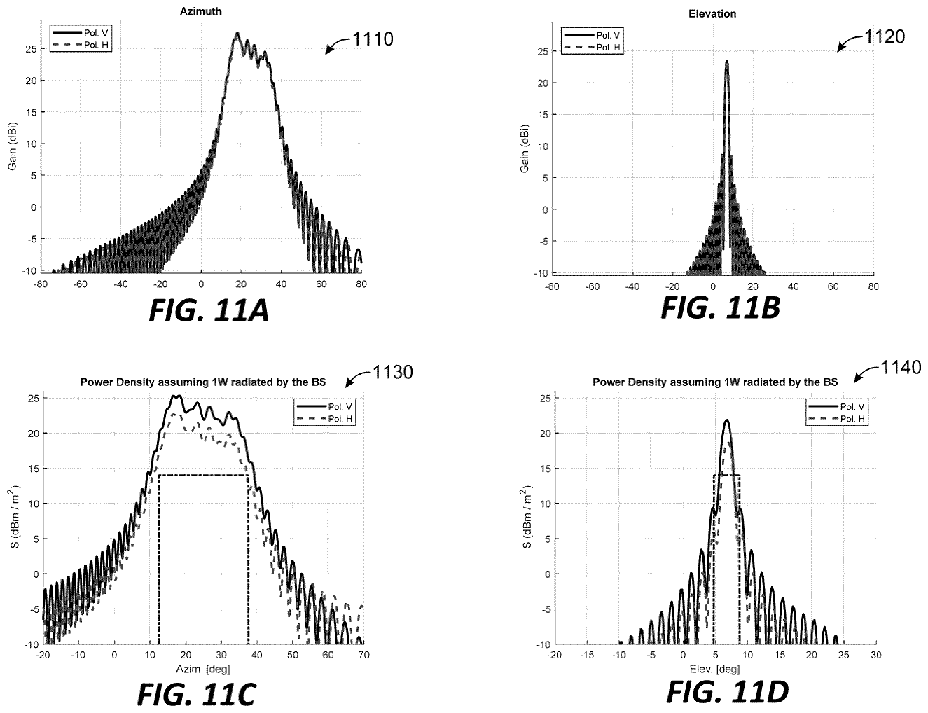

FIGS. 11A-11D illustrate plot diagrams of main cuts in azimuth and elevation of far-field radiation patterns and near-field radiated power density of a defocused beam of a reflectarray in accordance with various implementations of the subject technology. In FIG. 11A, plot 1110 represents the main cut of the far field radiation pattern in azimuth for polarization in V and H directions. The radiation pattern signal shown in the plot 1110 has a current gain up to 27 dBi that is computed within an azimuth angle range of −80° to +80°, showing some ripple and decreasing gain with higher radiation angle. FIG. 11B illustrates a far field radiation pattern 1120 that represents the main cut of the far field radiation pattern in elevation for polarization in V and H directions. The radiation pattern signal shown in the plot 1120 has a current gain up to 23 dBi that is computed within an elevation angle range of −12° to +28°. The maximum gain correspond to the value at the center of the coverage in the FIG. 11A cut. As illustrated in FIGS. 11C and 11D, plots 1130 and 1140 respectively depict the near-field patterns obtained at a prescribed distance for the same reflectarray. They show similar ripples as in the far field patterns. Because of the computation in the near field gain cannot be computed any more (this is a far-field parameter) but the spatial power density provides the information on the power radiated. In particular, plots 1130 and 1140 show spatial power density as a function of azimuth angles and elevation angles, respectively. Assuming the radiation power is 1 watt and radiated by a base station, the pattern obtained in the elevation versus in the azimuth can be different, as shown in the plots 1130 and 1140. Note that the radiation pattern in the elevation does not fulfill the requirements since no defocusing is applied in this plane.

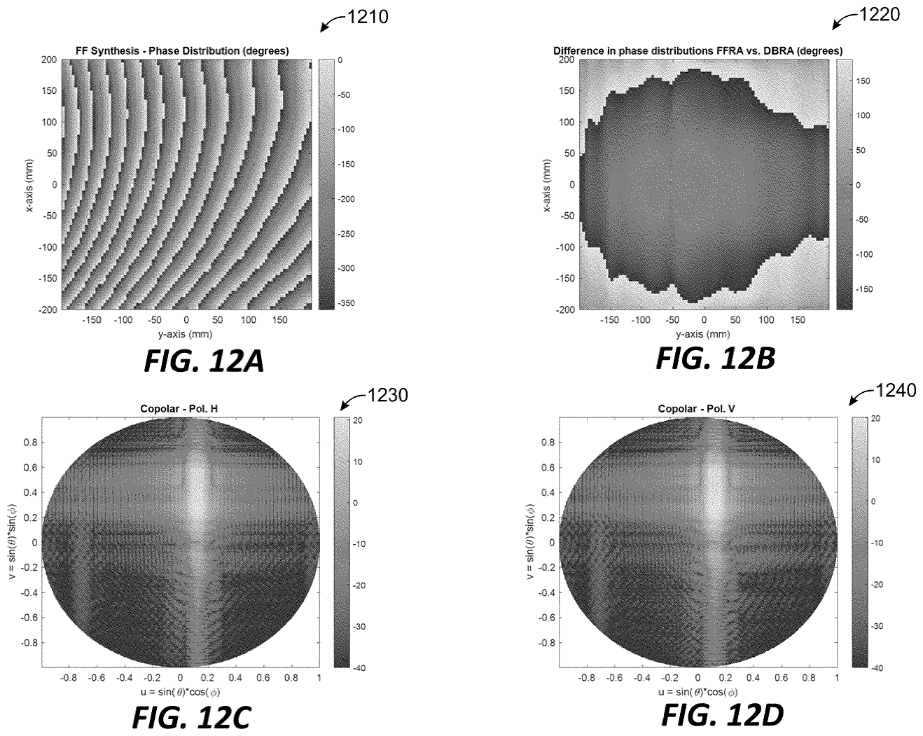

FIGS. 12A-12D illustrate plot diagrams of phase distribution using a far field synthesis versus defocused beam synthesis as well as far field radiation patterns produced by the far field synthesis for a given reflectarray cell in accordance with various implementations of the subject technology. As illustrated in FIG. 12A, plot 1210 represents the synthesized phase distribution that is output from the far field pattern synthesis operation. In some implementations, the plot 1210 shows the phase distribution as a function of x-axis and y-axis where the broadening is observed in the azimuth (x-direction). The plot 1220 illustrated in FIG. 12B shows the difference between the phase distributions obtained using defocusing beam reflectarray (starting point) and far field reflect array (result of the synthesis), which are described with respect to FIGS. 10A-10C and FIGS. 11A-11D. As further illustrated in FIGS. 12C and 12D, the 3-dimensional far field radiation patterns shown in plots 1230 and 1240 use the result of the far-field synthesis are plotted in the polarization directions H and V. As illustrated, the 3-dimensional far field radiation patterns show how the beams have broader coverage in both the azimuth plane (v-axis) and in the vertical plane (u-axis).

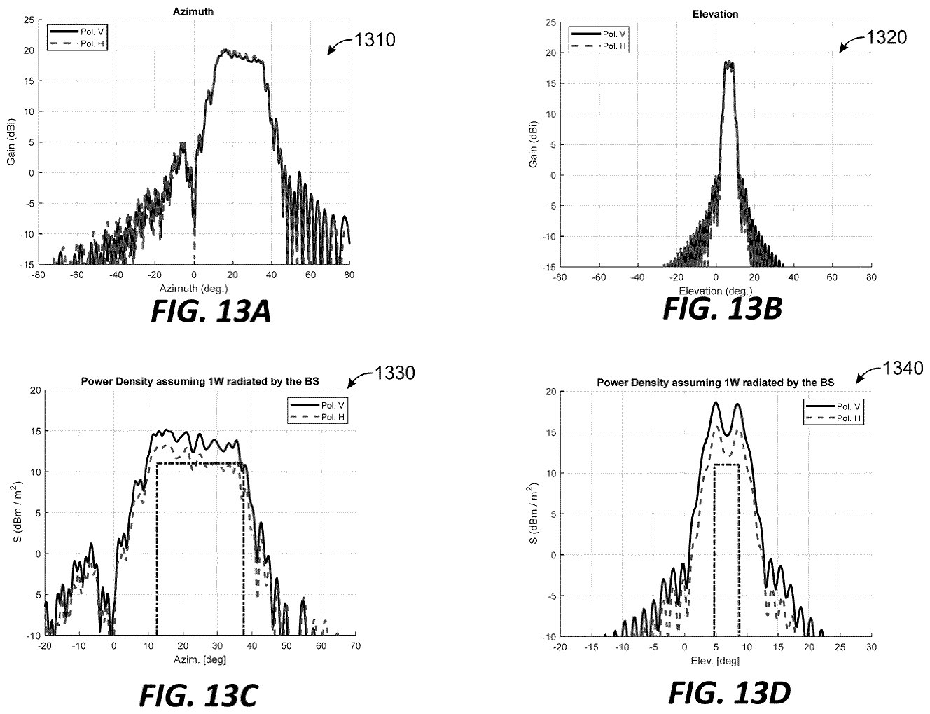

FIGS. 13A-13D illustrate plot diagrams of main cuts in azimuth and elevation of far-field radiation patterns and near-field radiated power density based on far field synthesis of a reflectarray in accordance with various implementations of the subject technology. In FIG. 13A, plot 1310 represents the main cut of the far field radiation pattern in azimuth showing wide and smooth coverage in the azimuth for polarization in V and H directions but decreasing the gain for broader angles. The radiation pattern signal shown in the plot 1310 has a current gain up to 20 dBi that is computed within an azimuth angle range of −80° to +80°. FIG. 13B illustrates a far field radiation pattern in the plot 1320 that represents the main cut of the far field radiation pattern in elevation for polarization in V and H directions, showing the pencil beam in FIG. 11B is transformed into a flat-top beam in a narrow angular sector. The radiation pattern signal shown in the plot 1320 has a current gain up to 18 dBi that is computed within an elevation angle range of −27° to +38°. As shown in the plots 1310 and 1320, the ripple is lower than 2 dB.

As illustrated in FIGS. 13C and 13D, plots 1330 and 1340 respectively depict the near-field patterns corresponding to those in far-field in FIGS. 13A and B, showing similar or higher ripples as in the far field patterns. In particular, plots 1330 and 1340 show power density as a function of azimuth angles and elevation angles, respectively. Assuming the radiation power is 1 watt and radiated by a base station, the radiation pattern obtained at a distance of 10 meters in the elevation versus in the azimuth can be different, as shown in the plots 1330 and 1340. Note that the radiation patterns in both plots 1330 and 1340 show strong distortions and the ripple is about 3 dB.

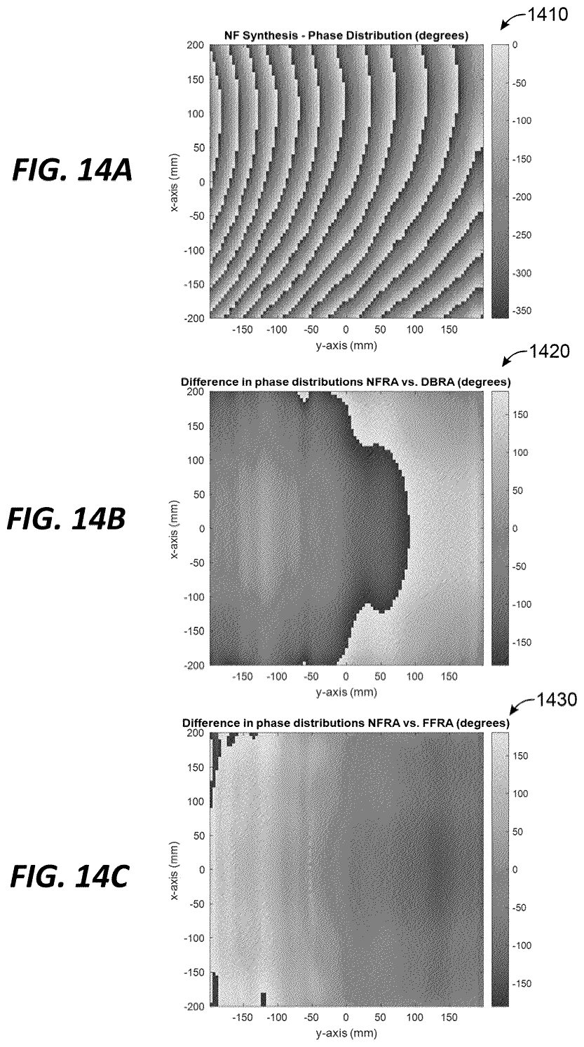

FIGS. 14A-14C illustrate phase distribution using a near field synthesis versus defocused beam and far field synthesis approaches in accordance with various implementations of the subject technology. As illustrated in FIG. 14A, plot 1410 represents the phase distribution synthesized using near field pattern synthesis operation. The plot 1410 shows the phase distribution as a function of x-axis and y-axis based on the near field pattern synthesis as disclosed with respect to FIGS. 3 and 7. The results of the near field pattern synthesis are compared with those of defocused beam synthesis as illustrated in plot 1420 of FIG. 14B. Similarly, the results of the near field pattern synthesis are compared with those of far field synthesis as illustrated in plot 1430 of FIG. 14C.

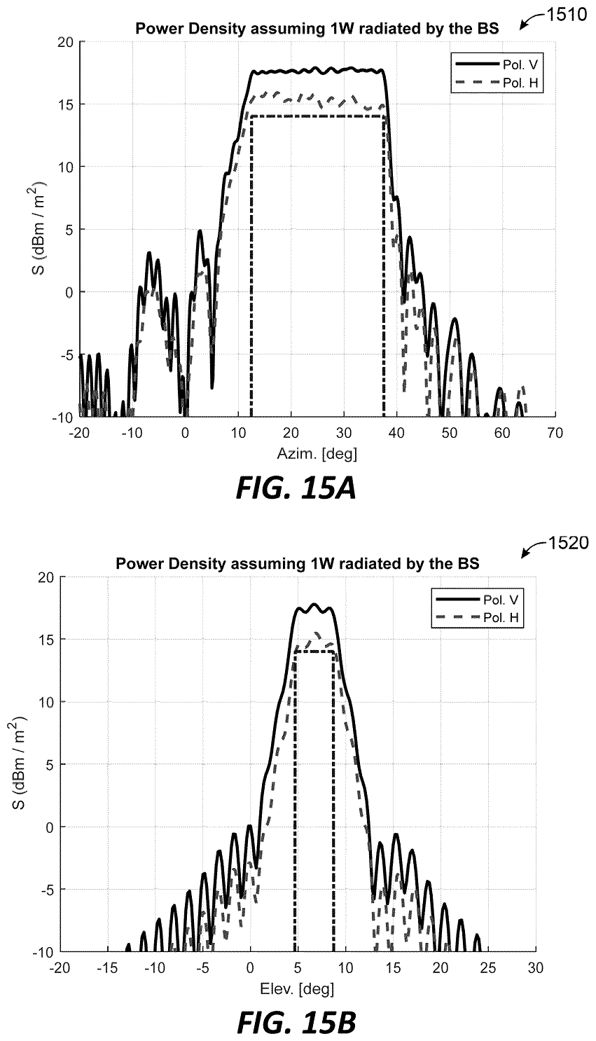

FIGS. 15A and 15B illustrate plot diagrams of main cuts in azimuth and elevation of near-field radiated power density based on near field pattern synthesis of a reflectarray in accordance with various implementations of the subject technology. As illustrated in FIGS. 15A and 15B, plots 1510 and 1520 respectively depict example near field patterns that that are calculated for a distance of 10 meters. Compared to the plots 1330 and 1340 described with respect to FIGS. 13C and 13D, the plots 1510 and 1520 show that the ripple is lower and the power level is higher than those calculated with the far field approach as shown in the plots 1330 and 1340. Similar to the plots 1330 and 1340, the power density calculated as a function of azimuth angles and elevation angles, respectively, at a distance of 10 meters is illustrated in the plots 1510 and 1520 based on 1 watt of radiated power by the base station.

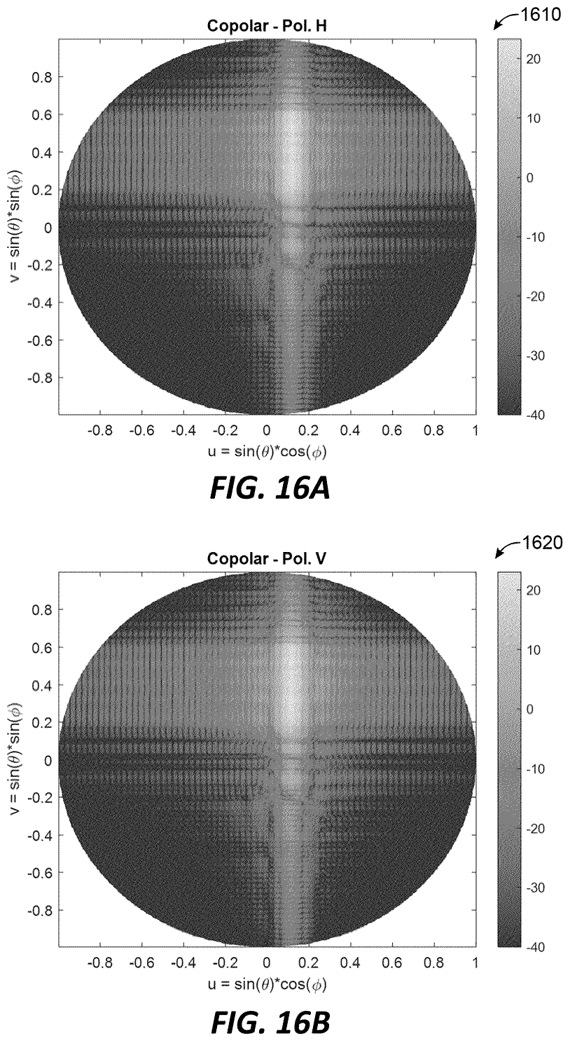

FIGS. 16A and 16B illustrate plot diagrams of far field radiation patterns based on near field synthesis for a reflectarray cell in accordance with various implementations of the subject technology. The far field patterns shown in plots 1610 and 1620 are plotted in the polarization directions H and V. The far field patterns are computed starting from the phase distribution shown in FIG. 14A (the result of near-field synthesis), in order to compare the two syntheses in near-field and far field respectively. For the near field synthesis reflectarray, the coverage is azimuth is achieved, but not in elevation (u-axis), the obtained coverage is narrower than in the far field case, which demonstrate that near-field and far-field syntheses provide control in near field and far field regions respectively but not in both at the same time.

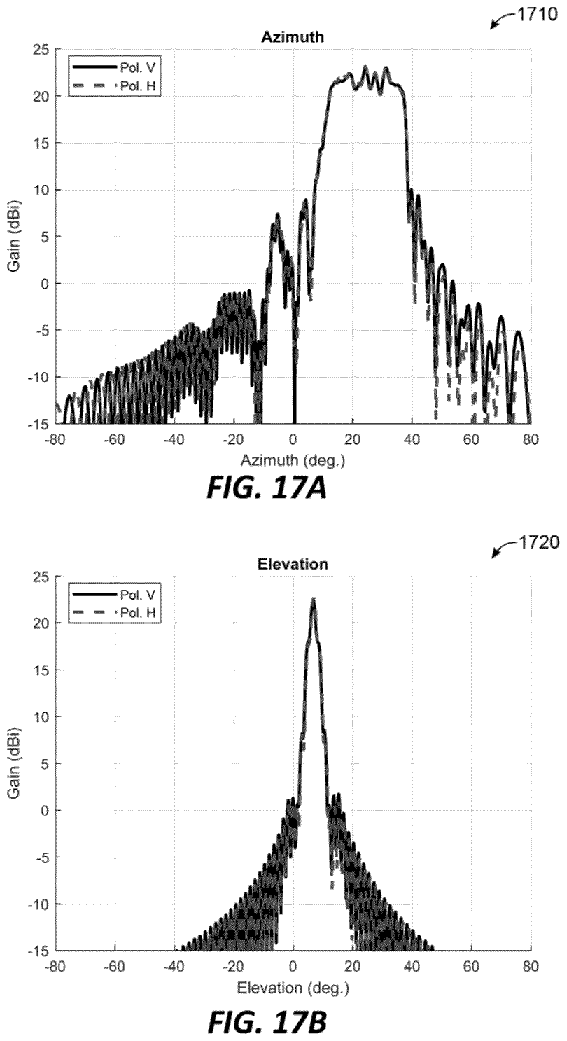

FIGS. 17A and 17B illustrate plot diagrams of main cuts in azimuth and elevation of far field radiation patterns based on near field pattern synthesis of a reflectarray in accordance with various implementations of the subject technology. In FIG. 17A, plot 1710 represents the main cut of the far field radiation pattern in azimuth showing higher ripple in the azimuth for polarization in both V and H directions than in the case of far-field synthesis (FIG. 13A). The radiation pattern signal shown in the plot 1710 has a current gain up to 23 dBi that is computed within an azimuth angle range of −80° to +80°. FIG. 17B illustrates a near field radiation pattern in the plot 1720 that represents the main cut of the far field radiation pattern in elevation for polarization in both V and H directions. The radiation pattern signal shown in the plot 1720 has a current gain up to 23 dBi that is computed within an elevation angle range of −38 to +48°. As shown in the plots 1710 and 1720, the ripple is higher in the azimuth and the beam is narrower in the elevation compared with far-field synthesis, and as a result, the narrower beam leads to a higher gain.

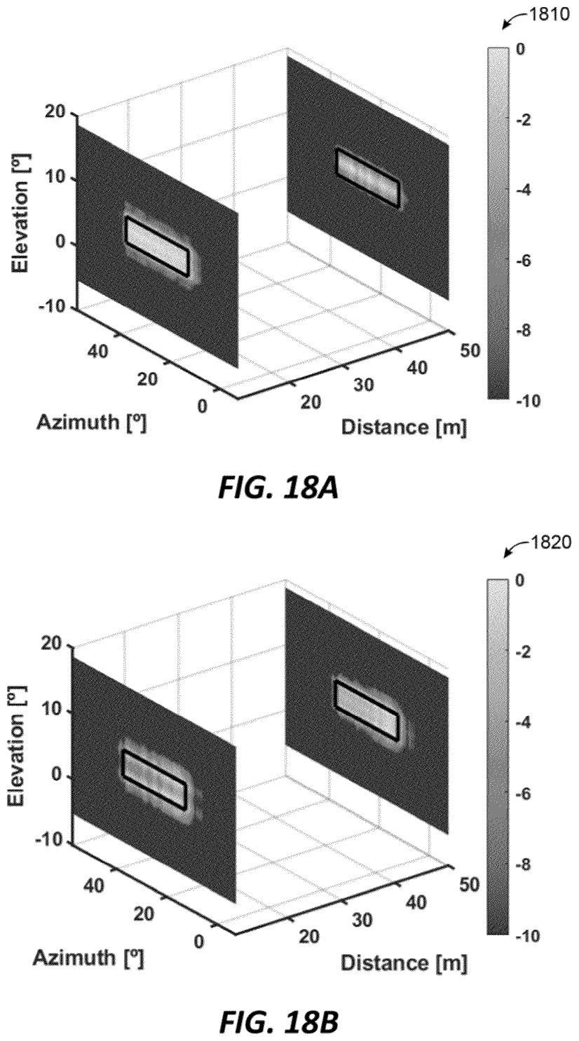

FIGS. 18A and 18B illustrate 3D plot diagrams of field radiated at different distances for a reflectarray cell using near field (A) and far field (B) approaches in accordance with various implementations of the subject technology. As depicted in FIGS. 18A and 18B, the plots 1810 of FIG. 18A and 1820 of FIG. 18B show coverage of signal obtained at distances of 10 meters and 50 meters for near field pattern synthesis as shown in plot 1810 and for far field pattern synthesis as shown in plot 1820. The intensity of the signals is shown is in with just 10 dB range to appreciate the ripple and is normalized to the maximum in the coverage, defined by a black rectangle in the plots 1810 and 1820. As shown in the figures, the near-field synthesis provides uniform intensity (coverage) at 10 meters (plot 1810) but not at 50 meters. On the other hand, the far-field synthesis shown in plot 1820 demonstrates low ripple at 50 meters but high at 10 meters resulting in an unstable coverage in near-field.

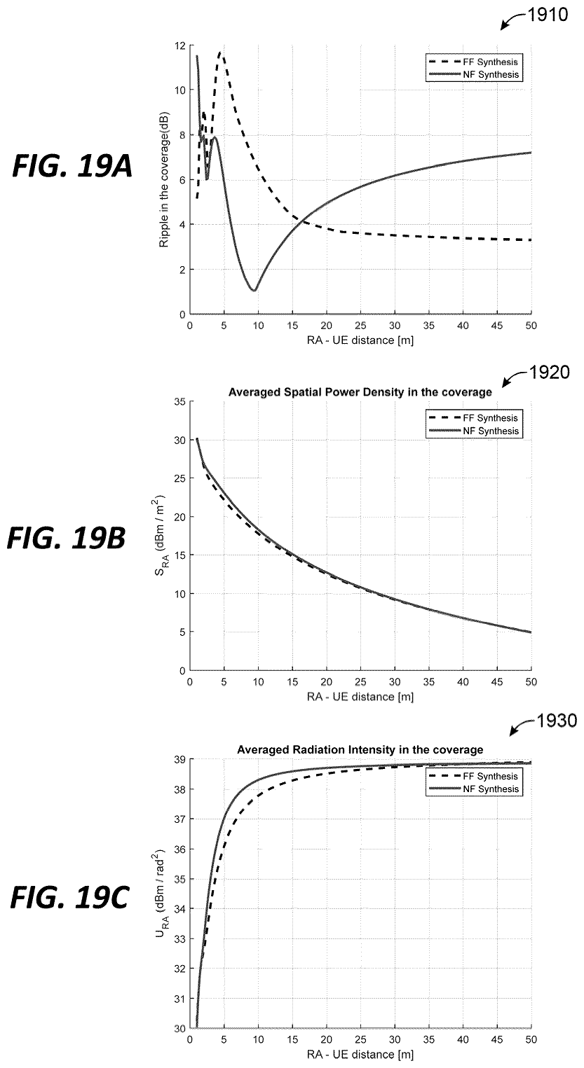

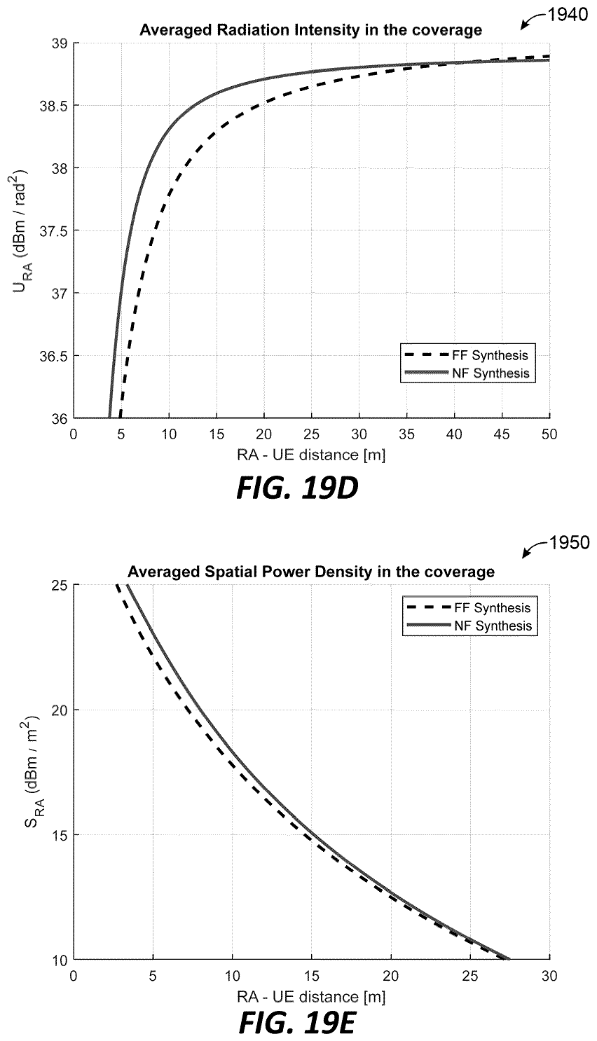

FIGS. 19A-19E illustrate comparison diagrams (ripple in the coverage, power density in the coverage and radiation intensity) calculated at different distances for a reflectarray cell in accordance with various implementations of the subject technology. The plot 1910 illustrated in FIG. 19A is the ripple of signal intensity achieved in coverage (dB) as a function of distance (of a user equipment) from the reflectarray for both near field synthesis and far field synthesis. The plot demonstrates that around 10 meters the result of near-field synthesis is much uniform (less ripple). This distance is the nominal distance used in the synthesis process and can be modified according to the coverage requirement. On the other hand, the result of far-field synthesis provide low ripple at distances far from the reflectarray, which corresponds with far field radiative region. The plot 1920 illustrated in FIG. 19B is an averaged spatial power density in the coverage as a function of distance of the user equipment from the reflectarray for both near field synthesis and far field synthesis. In this case the result is similar in both cases since this depends mainly on the power reflected by the reflectarray, which is a function of size of the reflectarray and optics of the feeder (the base station) and these parameters are the same in both cases for a fair comparison. The result for near field synthesis shows slight superior performance at distances around 10 meters (the distance used for the synthesis process). The plot 1930 illustrated in FIG. 19C is an averaged radiation intensity in the coverage as a function of distance of the user equipment from the reflectarray for both near field synthesis and far field synthesis. The performance is similar to the previous figure but the difference at 10 meter distance is more clear when radiation intensity is calculated. The plot 1940 illustrated in FIG. 19D is an averaged radiation intensity in the coverage as a function of distance of the user equipment from the reflectarray for both near field synthesis and far field synthesis. This is a zoom in plot of plot 1930. The plot 1950 illustrated in FIG. 19E is an averaged spatial power density in the coverage as a function of distance of the user equipment from the reflectarray for both near field synthesis and far field synthesis. In sum, the plots 1910-1950 illustrate that in near field region, the near field pattern synthesis approach shows superior performance while in the far field region, the performance of the near field approach converges to similar values with slightly superior performance of the far field pattern synthesis.

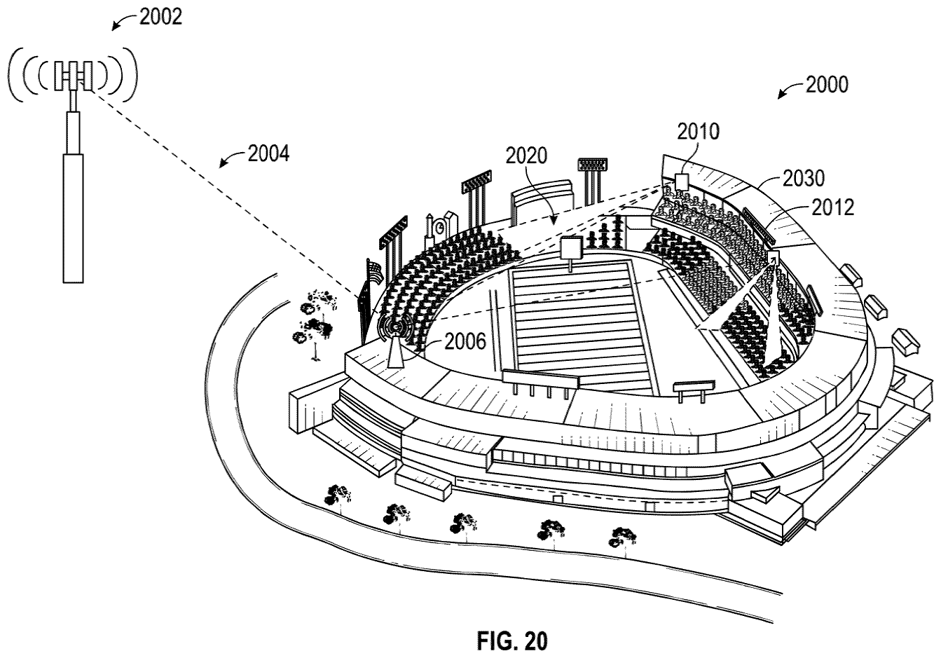

FIG. 20 conceptually illustrates an example of reflectarray antennas in an outdoor environment 2000 in accordance with various implementations of the subject technology. A wireless base station (BS) 2002 transmits to and receives wireless signals 2004 from a wireless radio 2006 that is installed on the roof of a stadium 2030. The wireless radio 2006 may transmit to and receive wireless signals from mobile devices within its coverage area. The coverage area may be disrupted by buildings or other structures in the outdoor environment, which may affect the quality of the wireless signals. As depicted in FIG. 20, the stadium 2030 and its structural features can affect the coverage area of the BS 2002 and/or the wireless radio 2006 such that it has a Line-of-Sight (LOS) zone. The UEs that are outside of the LOS zone may have either no wireless access, significantly reduced coverage, or impaired coverage. Given the very high frequency bands (e.g., millimeter wave frequencies) utilized for 5G network traffic, it may be difficult to expand the coverage area outside the LOS zone of the wireless radio 2006.

Wireless coverage can be significantly improved to users outside of the LOS zone by the installation of reflectarray antennas on a surface of a structure (e.g., roof, wall, post, window, etc.). As depicted in FIG. 20, reflectarray antennas 2010 and 2012 are placed at distinct locations of the stadium 2030. For example, each reflectarray antenna may be placed on a roofline edge.

Each of the reflectarray antennas 2010 and 2012 is a robust and low-cost passive relay antenna that is positioned at an enhanced location to significantly improve network coverage. As illustrated, each of the reflectarray antennas 2010 and 2012 is formed, placed, configured, embedded, or otherwise connected to a portion of the stadium 2030. Although multiple reflectarrays are shown for illustration purposes, a single reflectarray may be placed in external and/or internal surfaces of the stadium 2030 depending on implementation.

In some implementations, each of the reflectarray antennas 2010 and 2012 can serve as a passive relay between the wireless radio 2006 and end users within or outside of the LOS zone. In other implementations, the reflectarray antennas 2010 and 2012 can serve as active relays by providing an increase in transmission power to the reflected wireless signals. End users in a Non-Line-of-Sight (“NLOS”) zone can receive wireless signals from the wireless radio 2006 that are reflected from the reflectarray antennas 2010 and 2012. In some implementations, the reflectarray antenna 2010 may receive a single RF signal from the wireless radio 2006 and redirect that signal into a focused beam 2020 to a targeted location or direction. In other implementations, the reflectarray antenna 2012 may receive a single RF signal from the wireless radio 2006 and redirect that signal into multiple reflected signals 2022 at different phases to different locations. Various configurations, shapes, and dimensions may be used to implement specific designs and meet specific constraints. The reflectarray antennas 2010 and 2012 can be designed to directly reflect the wireless signals from the wireless radio 2006 in specific directions from any desired location in the illustrated environment.

For the UEs and others in the outdoor environment 2000, the reflectarray antennas 2010 and 2012 can achieve a significant performance and coverage boost by reflecting RF signals from BS 2002 and/or the wireless radio 2006 to strategic directions. The design of the reflectarray antennas 2010 and 2012 and the determination of the directions that each respective reflectarray needs to reach for wireless coverage and performance improvements take into account the geometrical configurations of the outdoor environment 2000 (e.g., placement of the wireless radio 2006, distances relative to the reflectarray antennas 2010 and 2012, etc.) as well as link budget calculations from the wireless radio 2006 to the reflectarray antennas 2010 and 2012 in the outdoor environment 2000. For example, the design and optimization of the reflectarray antennas 2010 and 2012 by performing a novel pattern synthesis operation that defines a single layered dual-linear polarized reflectarray antenna for large angles of incidence as described herein, can help achieve the desired area of coverage in LOS and NLOS zones.

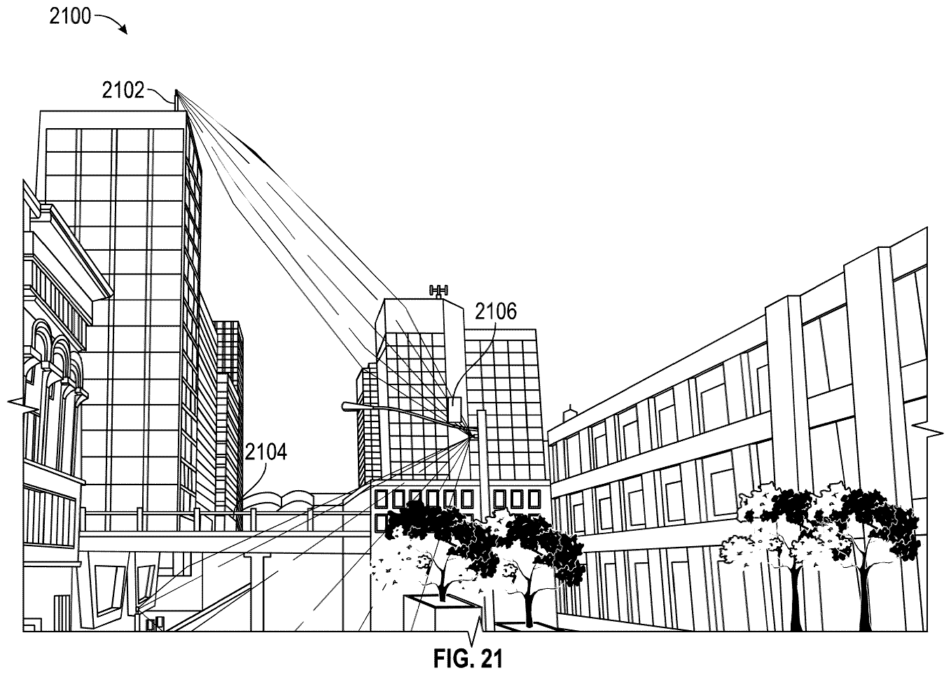

FIG. 21 shows another environment in which a reflectarray can be deployed to significantly improve wireless coverage and performance. In environment 2100, BS 2102 is located on top of a building that makes it difficult for it to provide good wireless coverage and performance to UE within its reach, including UE that may be located in NLOS areas underneath bridge 2104. For those UE and others in environment 2100, reflectarray 2106 achieves a significant performance and coverage boost by reflecting RF signals from UE to a focused direction to BS 2102. The design of the reflectarray 2106 takes into account the geometrical configurations of the environment 2100 (e.g., placement of BS 2102, distance relative to reflectarray 2106, etc.) as well as link budget calculations from BS 2102 to reflectarray 2106 in environment 2100, as described above in more detail.

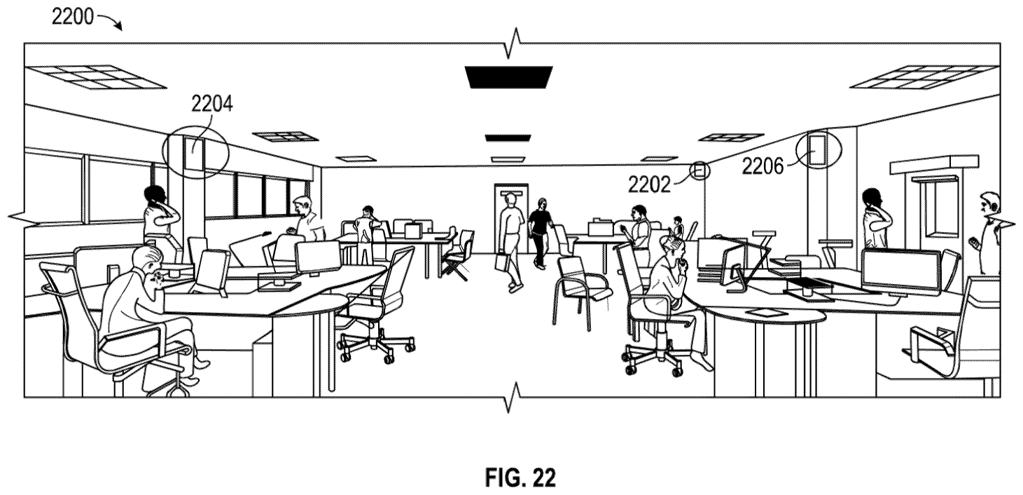

Note that reflectarrays can be placed in both outdoor and indoor environments. FIG. 22 illustrates placement of reflectarrays in an indoor environment according to various examples. Room 2200 has a wireless radio 2202 placed in one of its corners. Radio 2202 provides wireless coverage to UE in room 2200, such as within a fixed wireless network. There may be any number of UE in room 2200 at any given time with a high demand for high speed data communications. Placement of reflectarrays 2204-2206 in pre-determined locations enables RF waves from UE in room 2200 to reach wireless radio 2202 and provide a performance boost. The performance boost achieved by the reflectarrays 2204-2206 is due to the constructive effect of the directed beams reflected from all its cells and their conductive printed elements. Note that the constructive effect is achieved with a passive (or active), low cost and easy to manufacture reflectarray that is crucial for enabling 5G wireless communications and other data intensive wireless applications. In addition to many configurations, the reflectarrays disclosed herein are able to generate narrow or broad beams as desired, e.g., narrow in azimuth and broad in elevation, at different frequencies (e.g., single, dual, multi-band or broadband), with different materials, and so forth. The reflectarrays can reach a wide range of directions and locations in any wireless environment. These reflectarrays are low cost, easy to manufacture and set up, and may be self-calibrated without requiring manual adjustment to its operation.

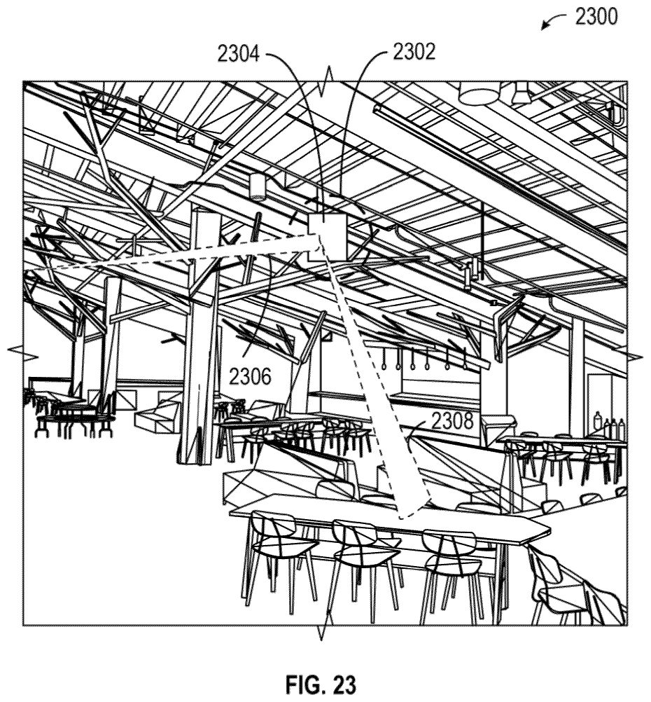

FIG. 23 conceptually illustrates an example of a reflectarray antenna 2304 with placement in an indoor environment 2300 in accordance with various implementations of the subject technology. The indoor environment 2300 may have a wireless radio placed in a predetermined location (not shown) for transmitting wireless communication signals to UE (e.g., cellular phones). For example, the wireless radio may provide wireless network coverage to one or more UEs located within the indoor environment 2300, such as within a fixed wireless network. There may be any number of UEs in indoor environment 2300 at any given time with a high demand for high-speed data communications. Placement of a reflectarray antenna 2304 at a location 2302 may be determined through scanning results from a scanning system (not shown) such that the reflectarray antenna 2304 can enable RF waves (e.g., 2306) from the wireless radio to reach any direction with relayed RF waves 2308 and provide a performance boost to the original RF signal. The performance boost achieved by the reflectarray antenna 2304 may be due to the constructive effect of the directed beams reflected from all of the cells in the reflectarray antenna 2304 and conductive printed elements in such cells. The constructive effect may be achieved with a passive (or active), low cost and easy to manufacture reflectarray that is crucial for enabling 5G applications. In addition to many configurations, the reflectarrays disclosed herein can generate narrow or broad beams as desired, e.g., narrow in azimuth and broad in elevation, at different frequencies (e.g., single, dual, multi-band or broadband), with different materials, and so forth. The reflectarrays can reach a wide range of directions and locations in any wireless network environment. The reflectarrays can be low cost, easy to manufacture and set up, and may be self-calibrated without requiring manual adjustment to its operation. In some implementations, the reflectarray antenna 2304 may include a meta-structure.

FIG. 24 conceptually illustrates an electronic system 2400 with which one or more implementations of the subject technology may be implemented. The electronic system 2400, for example, can be a computer, a server, or generally any electronic device that executes a program to design and optimize a reflectarray antenna design by computer modeling. Such an electronic system includes various types of computer readable media and interfaces for various other types of computer readable media. The electronic system 2400 includes a bus 2408, one or more processing unit(s) 2412, a system memory 2404 (and/or buffer), a read-only memory (ROM) 2410, a permanent storage device 2402, an input device interface 2414, an output device interface 2406, and one or more network interfaces 2416, or subsets and variations thereof.

The bus 2408 collectively represents all system, peripheral, and chipset buses that communicatively connect the numerous internal devices of the electronic system 2400. In one or more implementations, the bus 2408 communicatively connects the one or more processing unit(s) 2412 with the ROM 2410, the system memory 2404, and the permanent storage device 2402. From these various memory units, the one or more processing unit(s) 2412 retrieves instructions to execute and data to process in order to execute the processes of the subject disclosure. For example, the processing unit(s) 2412 can execute instructions that perform one or more processes, such as processes 300 and 700. The one or more processing unit(s) 2412 can be a single processor or a multi-core processor in different implementations.

The ROM 2410 stores static data and instructions that are needed by the one or more processing unit(s) 2412 and other modules of the electronic system 2400. The permanent storage device 2402, on the other hand, may be a read-and-write memory device. The permanent storage device 2402 may be a non-volatile memory unit that stores instructions and data even when the electronic system 2400 is off. In one or more implementations, a mass-storage device (such as a magnetic or optical disk and its corresponding disk drive) may be used as the permanent storage device 2402.

In one or more implementations, a removable storage device (such as a floppy disk, flash drive, and its corresponding disk drive) may be used as the permanent storage device 2402. Like the permanent storage device 2402, the system memory 2404 may be a read-and-write memory device. However, unlike the permanent storage device 2402, the system memory 2404 may be a volatile read-and-write memory, such as random access memory. The system memory 2404 may store any of the instructions and data that one or more processing unit(s) 2412 may need at runtime. In one or more implementations, the processes of the subject disclosure are stored in the system memory 2404, the permanent storage device 2402, and/or the ROM 2410. From these various memory units, the one or more processing unit(s) 2412 retrieves instructions to execute and data to process in order to execute the processes of one or more implementations.

The bus 2408 also connects to the input and output device interfaces 2414 and 2406. The input device interface 2414 enables a user to communicate information and select commands to the electronic system 2400. Input devices that may be used with the input device interface 2414 may include, for example, alphanumeric keyboards and pointing devices (also called “cursor control devices”). The output device interface 2406 may enable, for example, the display of images generated by electronic system 2400. Output devices that may be used with the output device interface 2406 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 24, the bus 2408 also couples the electronic system 2400 to a network (not shown) and/or to one or more devices through the one or more network interface(s) 2416, such as one or more wireless network interfaces. In this manner, the electronic system 2400 can be a part of a network of computers (such as a local area network (“LAN”), a wide area network (“WAN”), or an Intranet, or a network of networks, such as the Internet. Any or all components of the electronic system 2400 can be used in conjunction with the subject disclosure.

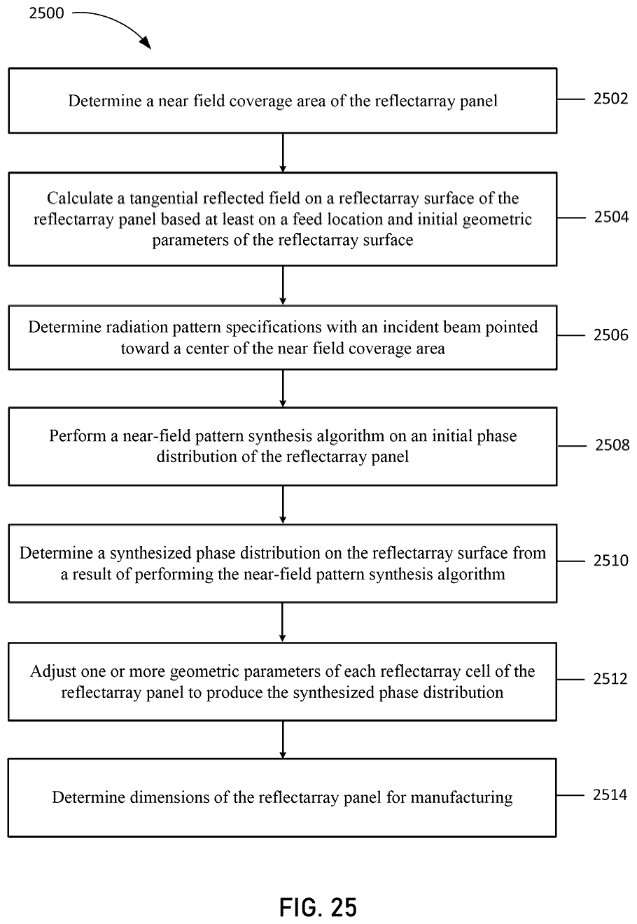

FIG. 25 illustrates a flowchart for a method 2500 of performing design of a reflectarray antenna for near-field wireless communication, in accordance with various implementations of the subject technology. As illustrated in FIG. 25, the method 2500 includes determining a near field coverage area of the reflectarray panel, at step 2502; calculating a tangential reflected field on a reflectarray surface of the reflectarray panel based at least on a feed location and initial geometric parameters of the reflectarray surface, at step 2504; determining radiation pattern specifications with an incident beam pointed toward a center of the near field coverage area, at step 2506; performing a near-field pattern synthesis algorithm on an initial phase distribution of the reflectarray panel, at step 2508; determining a synthesized phase distribution on the reflectarray surface from a result of performing the near-field pattern synthesis algorithm, at step 2510; adjusting one or more geometric parameters of each reflectarray cell of the reflectarray panel to produce the synthesized phase distribution, at step 2512; and determining dimensions of the reflectarray panel for manufacturing, at step 2514. Each of the method steps 2502, 2504, 2506, 2508, 2510, 2512, and 2514 can be implemented in accordance with various embodiments described above.

In various implementations of the near field pattern synthesis for the reflectarray antenna, the coverage area for near-field wireless communication is between about 1 meter and about 65 meters away from the reflectarray panel. In some embodiments, the coverage area can range from about 1.5 meters to about 61 meters. Depending on the operating frequency and the dimension of the reflectarray panel, the coverage area is between λ and

$$\sqrt{\frac{T}{2 λ}} \frac{T}{2} + λ ,$$

where T is \sqrt{2}·side length of the reflectarray panel, such as the reflectarray antenna 255 of FIG. 2B. In various embodiments, the coverage area is the Fresnel region between

$$\sqrt{\frac{T}{2 λ}} \frac{T}{2} + λ and \frac{2 {T}^{2}}{λ} + λ .$$

In various implementations of the method, the determined dimensions of the reflectarray panel include a layout of the reflectarray panel, an arrangement of one or more features of the reflectarray panel, and dimensions of patches in the reflectarray panel.

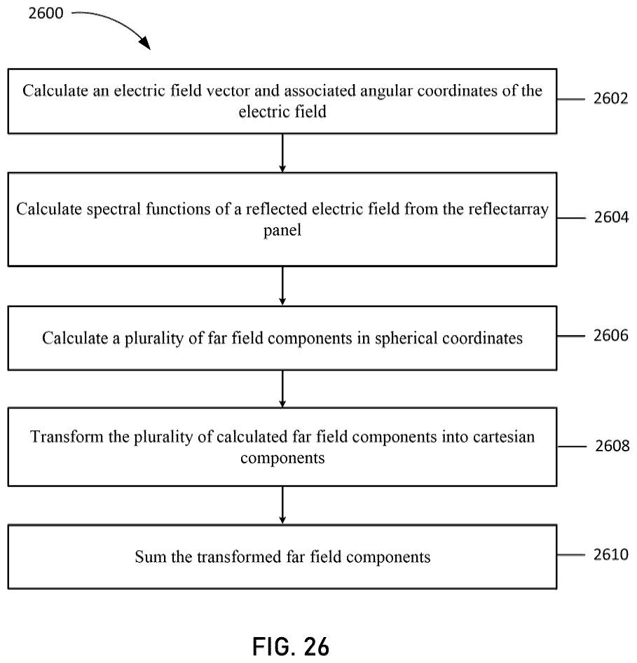

Now referring to FIG. 26, which illustrates a flowchart for a method 2600 of performing pattern synthesis of a reflectarray antenna for near-field wireless communication, in accordance with various implementations of the subject technology. As illustrated in FIG. 26, the method includes additional steps that can be implemented into the method 2500 as described with respect to FIG. 25. The method 2600 includes method steps for computing of the electric field at one or more selected points in the near-field coverage for each of the plurality of reflectarray antenna elements. The method 2600 includes at step 2602, calculating an electric field vector and associated angular coordinates of the electric field; at step 2604, calculating spectral functions of a reflected electric field from the reflectarray panel; at step 2606, calculating far field components in spherical coordinates; at step 2608, transforming the calculated far field components into cartesian components based, at least in part, on a distance between a user device and the reflectarray panel; and at step 2610, summing the transformed far field components. Each of the method steps 2602, 2604, 2606, 2608, and 2610 can be implemented in accordance with various embodiments described above, including but not limited to method steps in the method 2500.

In accordance with various embodiments and implementation disclosed herein, a method of designing a reflectarray panel for near-field wireless communication is described. The method includes determining a near field coverage area of the reflectarray panel, calculating a tangential reflected field on a reflectarray surface of the reflectarray panel based at least on a feed location and initial geometric parameters of the reflectarray surface, determining radiation pattern specifications with an incident beam pointed toward a center of the near field coverage area, performing a near-field pattern synthesis algorithm on an initial phase distribution of the reflectarray panel, determining a synthesized phase distribution on the reflectarray surface from a result of performing the near-field pattern synthesis algorithm, adjusting one or more geometric parameters of each reflectarray cell of the reflectarray panel to produce the synthesized phase distribution, and determining dimensions of the reflectarray panel for manufacturing.

In various embodiments, the determined dimensions of the reflectarray panel include a layout of the reflectarray panel, an arrangement of one or more features of the reflectarray panel, and dimensions of patches in the reflectarray panel.

In various implementations, performing the near-field pattern synthesis algorithm includes providing an electric field on the surface of the reflectarray panel comprising a plurality of reflectarray cells, obtained by applying a transformation from the electric field in the near-field coverage where the electric field is computed; and computing the electric field at the one or more selected points in near-field coverage by adding the contribution of the plurality of reflectarray cells.

In various implementations, the computing of the electric field at the one or more selected points in near-field coverage area further includes calculating an electric field vector and associated angular coordinates of the electric field; calculating spectral functions of a reflected electric field from the reflectarray panel; calculating far field components in spherical coordinates; transforming the calculated far field components into cartesian components based, at least in part, on a distance between a user device and the reflectarray panel; and summation of the transformed far field components.

In various implementations, the method further includes determining the initial phase distribution of an array of cells on the reflectarray surface of the reflectarray antenna based on a defocused beam pointed toward the coverage area at a predetermined azimuth angle and at a predetermined elevation angle.

In various implementations, the reflectarray panel includes a plurality of reflectarray cells, wherein each reflectarray cell further includes a first plurality of conductive elements configured to radiate reflected radio frequency (RF) beams with a first phase distribution in a first linear polarization; and a second plurality of conductive elements arranged orthogonally to the first plurality of conductive elements and configured to radiate reflected RF beams with a second phase distribution in a second linear polarization, wherein the first and the second phase distributions are computed to ensure that the radiated near field are the same in the first and the second linear polarizations.

In various embodiments, a passive reflectarray panel for near-field wireless communication applications is described. The passive reflectarray panel includes a substrate with a conductive ground plane and an array of reflectarray cells disposed on the substrate, the array of reflectarray cells configured to produce a phase distribution on the surface of the array of reflectarray cells using a near-field pattern synthesis algorithm, wherein the phase distribution for two orthogonal linear polarizations produces a reflected radio frequency (RF) power density in near-field according to a previously defined coverage pattern.

In various embodiments, each reflectarray cell includes a first plurality of conductive elements configured to produce a first phase-shift in a first linear polarization that contributes to the power density in near-field for a first linear polarization and a second plurality of conductive elements arranged orthogonally to the first plurality of conductive elements, configured to produce a second phase shift in a second linear polarization, orthogonal to the first polarization, that contributes to the power density in a second linear polarization with the same near-field coverage than in the first linear polarization.

In various embodiments, the first plurality of conductive elements include at least one dipole that extends laterally along a first axis and the second plurality of conductive elements comprises at least one dipole that extends laterally along a second axis orthogonal to the first axis. In various embodiments, the array of reflectarray cells has a periodicity of cells in a range of 3.0 millimeters (mm) to 5.0 mm in the first axis and the second axis.

In various embodiments, each of the first plurality of conductive elements and each of the second plurality of conductive elements comprises a plurality of dipoles having varying lengths, and wherein the plurality of dipoles for each of the first plurality of conductive elements and for each of the second plurality of conductive elements are arranged in parallel to one another. In various embodiments, each of the first plurality of conductive elements and the second plurality of conductive elements comprises a first dipole with a first length, a second dipole with a second length, and a third dipole with a third length, and wherein the second dipole is interposed between the first dipole and the third dipole. In various embodiments, the second length is greater than the first length and the third length, and wherein the first length is within a threshold amount of the third length. In various implementations, the second length is greater than the first length and the third length, and wherein the first length is within a threshold amount of the third length. In various implementations, the second length is greater than the first length and the third length, and wherein the first length is substantially equivalent to the third length. In various implementations, each of the first length and third length is a predetermined fraction of the second length.

In various embodiments, each reflectarray cell of the array of reflectarray cells comprises a substrate, a patterned layer with the first plurality of conductive elements and the second plurality of conductive elements, a ground plane layer, a bonding layer, and a superstrate, wherein the superstrate is disposed on a top surface of the bonding layer, the bonding layer is disposed on a top surface of the patterned layer, the patterned layer is disposed on a top surface of the substrate, and the substrate is disposed on a top surface of the ground plane layer. In various embodiments, the superstrate and the substrate comprise a same composite material.

In various implementations, each reflectarray cell of the array of reflectarray cells comprises a substrate, a patterned layer with the first plurality of conductive elements and the second plurality of conductive elements, a ground plane layer, a bonding layer, and a superstrate, wherein the superstrate is disposed on a top surface of the bonding layer, the bonding layer is disposed on a top surface of the patterned layer, the patterned layer is disposed on a top surface of the substrate, and the substrate is disposed on a top surface of the ground plane layer. In various implementations, the superstrate and the substrate comprise a same composite material. In various implementations, the first plurality of conductive elements and the second plurality of conductive elements are conductive printed patches of different shapes.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item).The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

1. A method of designing a reflectarray panel for near-field wireless communication, the method comprising:
determining a near field coverage area of the reflectarray panel;
calculating a tangential reflected field on a reflectarray surface of the reflectarray panel based at least on a feed location and initial geometric parameters of the reflectarray surface;
determining radiation pattern specifications with an incident beam pointed toward a center of the near field coverage area;
performing a near-field pattern synthesis algorithm on an initial phase distribution of the reflectarray panel;
determining a synthesized phase distribution on the reflectarray surface from a result of performing the near-field pattern synthesis algorithm;
adjusting one or more geometric parameters of each reflectarray cell of the reflectarray panel to produce the synthesized phase distribution; and
determining dimensions of the reflectarray panel for manufacturing.

2. The method of claim 1, wherein the determined dimensions of the reflectarray panel include a layout of the reflectarray panel, an arrangement of one or more features of the reflectarray panel, and dimensions of patches in the reflectarray panel.

3. The method of claim 1, wherein performing the near-field pattern synthesis algorithm comprises:
providing an electric field on the surface of the reflectarray panel comprising a plurality of reflectarray cells, obtained by applying a transformation from the electric field in the near-field coverage where the electric field is computed; and
computing the electric field at the one or more selected points in near-field coverage by adding the contribution of the plurality of reflectarray cells.

4. The method of claim 3, wherein the computing of the electric field at the one or more selected points in near-field coverage area further comprises:
calculating an electric field vector and associated angular coordinates of the electric field;
calculating spectral functions of a reflected electric field from the reflectarray panel;
calculating far field components in spherical coordinates;
transforming the calculated far field components into cartesian components based, at least in part, on a distance between a user device and the reflectarray panel; and
summing of the transformed far field components.

5. The method of claim 1, wherein the near-field coverage area is between 1 meter and 65 meters away from the reflectarray panel.

6. The method of claim 1, further comprising: determining the initial phase distribution of an array of cells on the reflectarray surface of the reflectarray antenna based on a defocused beam pointed toward the coverage area at a predetermined azimuth angle and at a predetermined elevation angle.

7. The method of claim 1, wherein the reflectarray panel comprises a plurality of reflectarray cells, wherein each reflectarray cell comprises:
a first plurality of conductive elements configured to radiate reflected radio frequency (RF) beams with a first phase distribution in a first linear polarization; and
a second plurality of conductive elements arranged orthogonally to the first plurality of conductive elements and configured to radiate reflected RF beams with a second phase distribution in a second linear polarization, wherein the first and the second phase distributions are computed to ensure that the radiated near field are the same in the first and the second linear polarizations.

8. A passive reflectarray panel for near-field wireless communication applications, comprising:
a substrate with a conductive ground plane; and
an array of reflectarray cells disposed on the substrate, the array of reflectarray cells configured to produce a phase distribution on the surface of the array of reflectarray cells using a near-field pattern synthesis algorithm, wherein the phase distribution for two orthogonal linear polarizations produces a reflected radio frequency (RF) power density in near-field according to a previously defined coverage pattern, and wherein each reflectarray cell comprises:
a first plurality of conductive elements configured to produce a first phase-shift in a first linear polarization that contributes to the power density in near-field for a first linear polarization; and
a second plurality of conductive elements arranged orthogonally to the first plurality of conductive elements, configured to produce a second phase shift in a second linear polarization, orthogonal to the first polarization, that contributes to the power density in a second linear polarization with the same near-field coverage than in the first linear polarization.

9. The reflectarray panel of claim 8, wherein the first plurality of conductive elements comprises at least one dipole that extends laterally along a first axis and the second plurality of conductive elements comprises at least one dipole that extends laterally along a second axis orthogonal to the first axis.

10. The reflectarray panel of claim 8, wherein the array of reflectarray cells has a periodicity of cells in a range of 3.0 millimeters (mm) to 5.0 mm in the first axis and the second axis.

11. The reflectarray panel of claim 8, wherein each of the first plurality of conductive elements and each of the second plurality of conductive elements comprises a plurality of dipoles having varying lengths, and wherein the plurality of dipoles for each of the first plurality of conductive elements and for each of the second plurality of conductive elements are arranged in parallel to one another.

12. The reflectarray antenna of claim 11, wherein each of the first plurality of conductive elements and the second plurality of conductive elements comprises a first dipole with a first length, a second dipole with a second length, and a third dipole with a third length, and wherein the second dipole is interposed between the first dipole and the third dipole.

13. The reflectarray antenna of claim 12, wherein the second length is greater than the first length and the third length, and wherein the first length is within a threshold amount of the third length.

14. The reflectarray antenna of claim 8, wherein each reflectarray cell of the array of reflectarray cells comprises a substrate, a patterned layer with the first plurality of conductive elements and the second plurality of conductive elements, a ground plane layer, a bonding layer, and a superstate, wherein the superstate is disposed on a top surface of the bonding layer, the bonding layer is disposed on atop surface of the patterned layer, the patterned layer is disposed on a top surface of the substrate, and the substrate is disposed on a top surface of the ground plane layer.

15. The reflectarray antenna of claim 14, wherein the superstate and the substrate comprise a same composite material.
